(19) United States
(12) Patent Application Publication
(10) Pub. No.: US 2026/0091471 A1
(43) Pub. Date: Apr. 2, 2026

(54) DEPTH SETTING BIT DRIVERS, SYSTEMS AND RELATED METHODS

(71) Applicant: Tech Products Co., Midland Park, NJ (US)

(72) Inventors: Robert WHITE, Midland Park, NJ (US); Ryan R. WHITE, Midland Park, NJ (US)

(73) Assignee: Tech Products Co., Midland Park, NJ (US)

(21) Appl. No.: 19/413,452

(22) Filed: Dec. 9, 2025

Related U.S. Application Data
(63) Continuation of application No. PCT/US2024/033314, filed on Jun. 10, 2024.
(60) Provisional application No. 63/507,445, filed on Jun. 9, 2023.

(51) Int. Cl. B25B 23/00; B25B 21/00

(52) U.S. Cl. CPC B25B 23/0064; B25B 21/002

(57) ABSTRACT

Depth setting bit drivers are provided. The drivers comprise a drive member comprising a drive spindle and a drive body with an adapter cavity and external first bearing surfaces, and a drive connector rotationally coupled and longitudinally fixed within the adapter cavity and a first bearing portion comprising an inner bit retention cavity and a plurality of external second bearing surfaces. The drivers further comprise a drive sleeve comprising a drive cavity comprising a disengagement portion and a clutch portion with internal third bearing surfaces. The first, second and third bearing surfaces are extended along two directions. The drive sleeve is telescopingly coupled with the drive member and the drive connector between a longitudinally-extended engaged arrangement with the first and second bearing surfaces engaged with the third bearing surfaces, and a longitudinally-retracted disengaged arrangement with one of the first and second bearing surfaces disengaged from the third bearing surfaces.

### CROSS REFERENCE TO RELATED APPLICATION

This application is a bypass continuation of International Patent Application No. PCT/US2024/033314, filed Jun. 10, 2024, entitled DEPTH SETTING BIT DRIVERS, SYSTEMS AND RELATED METHODS, which published as International Publication No. WO2024/254607 on Dec. 12, 2024, which perfects and claims the benefit of U.S. Provisional Ser. No. 63/507,445 , filed Jun. 9, 2023, entitled DEPTH SETTING BIT DRIVERS, SYSTEMS AND RELATED METHODS, which are each hereby incorporated herein by reference in their entireties.

### FIELD OF THE DISCLOSURE

The present disclosure is generally directed to depth setting bit drivers and related methods. More particularly, the present disclosure is directed to depth setting bit drivers with a plurality of circumferential mating bearing surfaces that are extended along two directions for high torque rotary driving tools, and related components, systems, kits and methods.

### BACKGROUND

Depth setters for rotary or torque tools are well known. Such devices are typically attached to the working end of a power rotary tool, such as a hand-held power drill driver, for drilling holes and driving threaded fasteners to specified depths. When configured as a drill bit driver to form a hole in a workpiece via the drill bit, such depth setters include a centrally located drill bit which is torqued or rotated by the powered rotary tool via the depth setter. When configured a fastener driver to drive a fastener into a workpiece, such depth setters include a centrally located driver bit which is torqued or rotated by the powered rotary tool via the depth setter.

Current rotary depth setters also typically include a workpiece collar at a distal end that extends about the bit, and an attachment end opposite the distal end which attaches to the drive mechanism of the powered rotary tool. During driving of a fastener or drill bit into a workpiece, the cylindrical collar acts as a stop when its edge portion contacts the outer surface of the workpiece at a predetermined depth of the fastener/drill bit.

Some current depth setters may include a clutch mechanism that interrupt transmission of torque to the bit or a fastener upon reaching a predetermined depth of penetration to prevent damage to a fastener and/or the workpiece after the depth is achieved. During a fastener driving operation with such depth setters, the driver bit tip engages the fastener while the cylindrical collar contacts the surface of the workpiece. Once contact is made and the depth setter is advanced a certain degree, a ball-bearing based clutch mechanism drivingly disengages the driver bit tip from the setter.

However, such ball-bearing based clutch mechanisms occasionally become mistakenly activated, such as due to high torque loads and/or vibratory and other miscellaneous forces during a driving operation with certain rotary tools. For example, impact and hammer rotatory tools apply periodic high torque loads which can unintentionally and/or prematurely disengage the ball-bearing clutch mechanisms of prior bit drivers. Further, such ball-bearing based clutch mechanisms of prior depth setting bit drivers cannot withstand the high torque loads of modern rotary tools (whether from impact and hammer rotatory tools, or modern direct drive rotary tools), as the ball bearings and/or the sloped bearing surfaces that they engage with wear and deform over a relatively short amount of time, which further contributes to unintentional and/or premature clutch disengagement or a complete failure of the clutch mechanism.

Accordingly, there is a need for improved depth setters for use with rotary-type power tools, that minimize marring or other damage to the surface of a workpiece and adequately withstand the high torque loads and wear associated with impact tools and other powerful modern rotary tools. There is also a need for depth setters that are manufacturable and cost efficient. There is also a need for depth setters that are easy to use, and may be used with readily available bits, such as standard widely-available fastener driver or power bits (e.g., standard screw/fastener drive bits (such as Torx® bits, Philips bits, etc. .), security bits, adapters, bit holders, nut drivers, etc. .) and drill bits, for example.

While certain aspects of conventional technologies have been discussed to facilitate disclosure of Applicant's inventions, the Applicant in no way disclaims these technical aspects, and it is contemplated that the inventions may encompass one or more conventional technical aspects.

In this disclosure, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY

The present inventions may address one or more of the problems and deficiencies of current depth setting drivers and related depth setting driving methods. However, it is contemplated that the inventions may prove useful in addressing other problems and deficiencies in a number of technical areas. Therefore, the claimed invention(s) should not necessarily be construed as limited to addressing any of the particular problems or deficiencies discussed herein.

The present disclosure is generally directed to depth setting bit drivers, and kits, systems and methods include at least one such depth setting bit driver, that rotate a bit about a longitudinal axis via bearing surfaces that adequately withstand the high torque loads of impact tools and other powerful modern rotary tools, until a particular depth is reached. The depth setting bit drivers comprise a drive member comprising a drive spindle and a drive body comprising an inner adapter cavity and external first bearing surfaces. The depth setting bit drivers also comprise a drive connector comprising a coupling portion rotationally coupled and longitudinally fixed within the adapter cavity, and a first bearing portion comprising an inner bit retention cavity and a plurality of external second bearing surfaces. The depth setting bit drivers further comprise a drive sleeve comprising a drive cavity comprising a disengagement portion a clutch portion with internal third bearing surfaces. The first, second and third bearing surfaces are circumferentially-arranged and extended along at least two directions, such as longitudinally and in at least one other direction. The drive sleeve is telescopingly coupled with the drive member and the drive connector between a longitudinally extended engaged arrangement with the first and second bearing surfaces engaged with the third bearing surfaces, and a longitudinally retracted disengaged arrangement with one of the first and second bearing surfaces disengaged from the third bearing surfaces.

In another aspect, the present disclosure provides depth setting bit drivers configured to rotate a bit about a longitudinal axis of the driver. The driver comprises a drive member comprising a drive spindle and a drive body, the drive body comprising an inner adapter cavity and a plurality of external circumferentially-arranged first bearing surfaces that are extended along two-dimensions. The driver also comprises a drive connector comprising a coupling portion rotationally coupled and longitudinally fixed within the adapter cavity and a first bearing portion. The first bearing portion comprises an inner bit retention cavity and a plurality of external circumferentially-arranged second bearing surfaces that are extended along two directions. The driver further comprises a drive sleeve comprising a longitudinal drive cavity comprising a disengagement portion with non-bearing internal surfaces and a clutch portion comprising a drive portion with a plurality of internal circumferentially-arranged third bearing surfaces that are extended along two directions. The driver also comprises a stop portion rotationally coupled to the drive sleeve comprising a longitudinal free end portion configured to engage a workpiece. The drive sleeve is telescopingly coupled with the drive member and the drive connector between a longitudinally extended engaged arrangement and a longitudinally retracted disengaged arrangement with respect thereto. In the longitudinally extended engaged arrangement, the first and second bearing surfaces are in engagement with the third bearing surfaces to rotationally lock the drive member and the drive connector. In the longitudinally retracted disengaged arrangement, one of the first and second bearing surfaces are positioned within the disengagement portion of the drive cavity to rotationally unlock the drive member and the drive connector.

In some embodiments, the drive body extends longitudinally from the drive spindle, and the adapter cavity extends longitudinally into the drive body from a longitudinal end of the drive body toward the spindle. In some such embodiments, the first bearing surfaces extend longitudinally from the longitudinal end of the drive body.

In some embodiments, the adapter cavity and the coupling portion each comprise an annular coupling recesses, and the coupling portion and the adapter cavity are rotationally coupled and longitudinally fixed via a retaining member extending within the coupling recesses. In some embodiments, the inner bit retention cavity defines a non-circular cross-section and is configured to retain and engage a driving stem of the bit that defines a non-circular cross-section such that the drive connector and the bit are rotationally fixed when the driving stem is positioned within the bit retention cavity. In some embodiments, the non-bearing internal surfaces of the disengagement portion define a larger opening within the drive cavity than an opening within the drive cavity defined by the third bearing surfaces of the clutch portion.

In some embodiments, an end portion of the first bearing portion defines the second bearing surfaces and is retained within the drive cavity. In some such embodiments, the drive cavity of the drive sleeve further comprises a neck portion and a bias portion, the neck portion being positioned longitudinally between the bias portion and the disengagement portion. In some such embodiments, the neck portion defines an opening within the drive cavity that is smaller than the end portion of the first bearing portion. In some other such embodiments, the driver further comprises a resilient member extending within the bias portion of the drive cavity longitudinally between the neck portion and a retaining member coupled to the drive body in a resiliently deformed state, the resilient member exerting a biasing force against the neck portion that biases the drive sleeve into the longitudinally extended engaged arrangement. In some embodiments, the drive sleeve is biased into the longitudinally extended engaged arrangement. In some embodiments, the first and bearing surfaces face radially outwardly, and the third bearing surfaces face radially inwardly.

In some embodiments, the first, second and third bearing surfaces extend longitudinally and are oriented parallel to the longitudinal axis as they extend longitudinally. In some embodiments, the first and second bearing surfaces are side surfaces of first spline features of the drive member and the drive connector, respectively, and the third bearing surfaces are side surfaces of second spline features of the drive sleeve, the first and second spline features forming a spline connection. In some embodiments, the first, second and third bearing surfaces comprise flat surfaces.

In some embodiments, the first, second and third bearing surfaces are extended longitudinally. In some such embodiments, the first, second and third bearing surfaces are extended along a lateral direction that extends perpendicular to the longitudinal axis. In some such embodiments, the lateral direction extends radially from the longitudinal axis. In some other such embodiments, the lateral direction extends perpendicular to a radial direction that extends radially from the longitudinal axis.

In some embodiments, in the longitudinally retracted disengaged arrangement, the one of the first and second bearing surfaces are positioned within the disengagement portion of the drive cavity and radially spaced from the non-bearing internal surfaces the disengagement portion.

In some embodiments, the diver is configured such that a tip of the bit extends past the longitudinal free end portion a first distance when a stem portion of the bit is retained within the bit retention cavity and the driver is in the longitudinally extended engaged arrangement, and such that the tip of the bit extends past the longitudinal free end portion a second distance that is greater than the first distance when the stem portion of the bit is retained within the bit retention cavity and the driver is in the longitudinally retracted disengaged arrangement. In some such embodiments, the second distance is within the range of about 2 mm and about 10 mm. In some embodiments, the longitudinal free end portion comprises a resilient material, the resilient material defining a longitudinal free end of the driver configured to engage the workpiece. In some such embodiments, the stop portion comprises a stop sleeve member that is rotationally coupled and longitudinally fixed to the drive sleeve, and the resilient material is coupled to a longitudinal end portion of the stop sleeve member. In some such embodiments, the stop sleeve member does not extend radially peripherally over the resilient material.

In some embodiments, the stop portion is rotationally coupled and longitudinally fixed to the drive sleeve. In some such embodiments, the stop portion comprises a stop sleeve member that extends circumferentially about a distal longitudinal portion of the drive sleeve and radially over a distal longitudinal free end of the drive sleeve. In some other such embodiments, the stop portion comprises a stop sleeve member that extends circumferentially about a distal longitudinal portion of the drive sleeve and radially over a distal longitudinal free end of the drive sleeve.

In some embodiments, the stop portion is rotationally coupled and longitudinally adjustably coupled to the drive sleeve. In some such embodiments, the stop portion comprises a depth adjustment member threadably coupled with the drive sleeve such that the first depth adjustment member is threadably longitudinally movable along the drive sleeve to adjust the longitudinal position of the longitudinal free end of the stop portion. In some such embodiments, the stop portion further comprises a locking member threadably coupled with the drive sleeve longitudinally adjacent to the depth adjustment member such that the locking member is threadably longitudinally movable along the drive sleeve and positionable into abutment with the depth adjustment member to prevent rotational and longitudinal translation of the depth adjustment member. In some other such embodiments, the stop portion further comprises a stop member rotationally coupled and longitudinally fixed to the depth adjustment member, the stop member comprising the longitudinal free end portion.

In some embodiments, in the longitudinally retracted disengaged arrangement, the first bearing surfaces are in engagement with the third bearing surfaces to rotationally lock the drive member and the drive sleeve, and the second bearing surfaces are positioned within the disengagement portion of the drive cavity of the drive sleeve to rotationally unlock the drive connector and the drive sleeve.

In some embodiments, in the longitudinally retracted disengaged arrangement, the second bearing surfaces are in engagement with the third bearing surfaces to rotationally lock the drive connector and the drive sleeve, and the first bearing surfaces are positioned within the disengagement portion of the drive cavity of the drive sleeve to rotationally unlock the drive member and the drive sleeve. In some such embodiments, the clutch portion of the drive cavity comprises a first clutch portion with a first set of bearing surfaces of the third bearing surfaces, and a second clutch portion with a second set of bearing surfaces of the third bearing surfaces, and the disengagement portion is positioned longitudinally between the first and second clutch portions. In some such embodiments, in the longitudinally retracted disengaged arrangement, the second bearing surfaces are in engagement with the second set of bearing surfaces of the third bearing surfaces. In some other such embodiments, in the longitudinally elongated engaged arrangement, the first bearing surfaces are in engagement with the first set of bearing surfaces of the third bearing surfaces and the second bearing surfaces are in engagement with the second set of bearing surfaces of the third bearing surfaces.

In another aspect, the present disclosure provides a kit or system that comprises a depth setting bit driver as disclosed herein, and at least one bit that is configured to removably couple within an adapter cavity of the depth setting bit driver and be rotated by the depth setting bit driver in a longitudinally extended engaged arrangement thereof.

In some embodiments, the at least one bit comprises a first bit configured as a fastener driving bit comprising a driving tip with a non-circular cross-section. In some such embodiments, the kit or system further comprises a plurality of fasteners comprising a head portion and an externally-threaded shaft portion extending longitudinally from the head portion, and the head portions of the fasteners comprise a driving feature with a non-circular cross-section configured to mate with the driving tip of the fastener driving bit.

In another aspect, the present disclosure provides bit drivers that comprise a drive member comprising a drive spindle and a drive body comprising a drive cavity, and a drive clutch telescopingly coupled with the drive body comprising a longitudinal bit through hole. The drive body and the drive clutch each include circumferentially-arranged bearing surfaces that are extended along two-dimensions and directly engage in a longitudinally extended engaged arrangement of the drive body and the drive clutch to rotationally lock the drive member and the drive clutch. The bit drivers are naturally biased into the engaged arrangement, and are configured to rearrange from the engaged arrangement to a longitudinally retracted disengaged arrangement with the first and second bearing surfaces disengaged to rotationally unlock the drive member and the drive clutch. The bit drivers may further comprise a stop sleeve that is rotationally coupled and longitudinally fixed to the drive clutch that minimizes marring or other damage to the surface of a workpiece. In use, the bit driver is rearranged from the longitudinally extended engaged arrangement to the longitudinally retracted disengaged arrangement to set or stop a depth of the driven bit into/towards a workpiece when the stop sleeve engages the workpiece and the drive member (and the driven bit via the drive member) is longitudinally translated toward the workpiece such that the bearing surfaces are translated longitudinally past each other (e.g., the bearing surfaces of the drive body translated longitudinally past the bearing surfaces of the drive clutch).

In another aspect, the present disclosure provides depth setting bit drivers, and kits, systems and methods that rotate a bit about a longitudinal axis that include at least one depth setting bit driver. The bit drivers comprise a drive member comprising a drive spindle and a drive body. The bit drivers also comprise a drive clutch telescopingly coupled with the drive body comprising a longitudinal bit through hole. The drive body and the drive clutch each include circumferentially-arranged bearing surfaces that are extended along two-dimensions and directly engage in a longitudinally extended engaged arrangement thereof to rotationally lock the drive member and the drive clutch. The bit drivers further comprise a stop sleeve rotationally coupled and longitudinally fixed to the drive clutch. The bit drivers are naturally biased into the engaged arrangement, and configured to rearrange from the engaged arrangement to a longitudinally retracted disengaged arrangement with the first and second bearing surfaces disengaged to rotationally unlock the drive member and the drive clutch.

In another aspect, the present disclosure provides depth setting bit drivers, and kits, systems and methods that include such a depth setting bit driver, that are configured to rotate a bit about a longitudinal axis of the driver. The depth setting bit driver comprises a drive member, a drive clutch, a stop sleeve and a resilient member. The drive member comprises a drive spindle and a drive body comprising a drive cavity, and the drive cavity comprises a bit retention portion and a clutch portion. The drive clutch extends within the clutch portion of the drive cavity and comprises a longitudinal through hole defining a non-circular cross-section that is substantially aligned with the bit retention portion of the drive cavity and a plurality of external circumferentially-arranged first bearing surfaces that are extended along two-dimensions. The stop sleeve comprises a sleeve portion extending about a portion of the drive body and a stop portion rotationally coupled and longitudinally fixed to the drive clutch. The stop portion comprises a longitudinal aperture substantially aligned with the bit retention portion of the drive cavity and the through hole of the drive clutch. The resilient member biases the drive clutch and the stop sleeve into a longitudinally extended engaged arrangement with respect to the drive member. The drive cavity comprises a disengagement portion with non-bearing internal surfaces and an engagement portion with a plurality of internal circumferentially-arranged second bearing surfaces, the disengagement portion being positioned longitudinally between the engagement portion and the drive spindle. In the longitudinally extended engaged arrangement, the first bearing surfaces extend within the engagement portion of the drive cavity and abut second bearing surfaces to rotationally lock the drive member and the drive clutch. The drive member, the drive clutch and the stop sleeve are configured to rearrange from the longitudinally extended engaged arrangement to a longitudinally retracted disengaged arrangement with the first bearing surfaces positioned within the disengagement portion of the drive cavity to rotationally unlock the drive member and the drive clutch.

In some embodiments, the drive body extends from the drive spindle and the drive cavity extends longitudinally into the drive body from a longitudinal end of the drive body toward the spindle. In some embodiments, the resilient member extends longitudinally within the drive cavity between a longitudinal end of the drive cavity and a longitudinal end of the drive clutch. In some such embodiments, the resilient member is a spring.

In some embodiments, the non-bearing internal surfaces of the disengagement portion define a larger opening within the drive cavity than an opening within the drive cavity defined by the second bearing surfaces of the engagement portion. In some embodiments, a base portion of the drive clutch that defines the second bearing surfaces is retained within the drive cavity. In some such embodiments, an outer portion of the drive cavity comprises a groove and a retaining ring retained within the groove, and the retaining ring defines an inner opening that is smaller than the base portion of the drive clutch prevent the base portion from translating out from the drive cavity.

In some embodiments, the first bearing surfaces face radially outwardly, and the first bearing surfaces face radially inwardly. In some embodiments, the first bearing surfaces extend longitudinally and are oriented parallel to the longitudinal axis as they extend longitudinally. In some embodiments, the first bearing surfaces are side surfaces of first spline features of the drive clutch, and the second bearing surfaces are side surfaces of second spline features of the engagement portion of the drive cavity, the first and second spline forming a spline connection. In some embodiments, the first and second bearing surfaces comprise flat surfaces.

In some embodiments, the first and second bearing surfaces are extended longitudinally. In some such embodiments, the first and second bearing surfaces are extended along a lateral direction that extends perpendicular to the longitudinal axis. In some such embodiments, the lateral direction extends radially from the longitudinal axis. In some other such embodiments, the lateral direction extends perpendicular to a radial direction that extends radially from the longitudinal axis.

In some embodiments, in the longitudinally retracted disengaged arrangement, the first bearing surfaces are positioned within and radially spaced from the disengagement portion of the drive cavity. In some such embodiments, the drive clutch comprises a drive portion that defines that the first bearing surfaces, and an intermediate portion that is longitudinally adjacent to the drive portion. In the longitudinally retracted disengaged arrangement, the intermediate portion extends within the engagement portion of the drive cavity and is radially spaced from the second bearing surfaces.

In some embodiments, the drive cavity, the longitudinal through hole and the longitudinal aperture are configured such that the bit extends longitudinally therethrough from bit retention portion. In some embodiments, the longitudinal through hole is configured to engage a driving portion of the bit that defines a non-circular cross-section such that the drive clutch and the bit are rotationally fixed. In some embodiments, the bit retention portion of the drive cavity comprises a groove and a resilient retaining ring within retained within the groove, and a base end portion of the bit comprises a groove configured to house the resilient retaining ring therein when the base end portion is translated into the resilient retaining ring so that the depth setting bit driver is removably coupled with the bit. In some embodiments, the diver is configured such that a tip of the bit extends past a longitudinal free end of the stop sleeve a first distance when a base portion of the bit is retained within the bit retention portion of the drive cavity and the driver is in the longitudinally extended engaged arrangement, and such that the tip of the bit extends past the longitudinal free end of the stop sleeve a second distance that is greater than the first distance when the base portion of the bit is retained within the bit retention portion of the drive cavity and the driver is in the longitudinally retracted disengaged arrangement.

In some embodiments, a longitudinal free end of the stop sleeve comprises a resilient material coupled thereto, the resilient material defining a longitudinal free end of the driver for engaging a workpiece. In some such embodiments, the stop portion of the stop sleeve defines the longitudinal free end of the stop sleeve. In some other such embodiments, the stop sleeve further comprises a depth adjustment member threadably coupled with the sleeve portion such that the first depth adjustment member is threadably longitudinally movable along the stop sleeve, and the depth adjustment member defines the longitudinal free end of the stop sleeve. In some such embodiments, the stop sleeve further comprises a locking member threadably coupled with the sleeve portion longitudinally adjacent to the depth adjustment member such that the locking member is threadably longitudinally movable along the stop sleeve and into abutment with the depth adjustment member.

In another aspect, the present disclosure provides a kit or system that comprises a depth setting bit driver as disclosed herein, and at least one bit configured to removably couple within and be rotated by the depth setting bit driver.

In some embodiments, the at least one bit comprises a first bit configured as a fastener driving bit comprising a driving tip with a non-circular cross-section. In some such embodiments, the at least one bit comprises a second bit, the first bit and the second bit comprising differing total longitudinal lengths between a driving base end and a driving tip thereof. In some other such embodiments, the kit or system further comprises a plurality of fasteners comprising a head portion and an externally-threaded shaft portion extending longitudinally from the head portion, and the head portions of the fasteners comprise a driving feature with a non-circular cross-section that corresponds to that of the driving tip of the fastener driving bit.

In some embodiments, the kit or system further comprises a plurality of fasteners comprising a head portion and an externally-threaded shaft portion extending longitudinally from the head portion, and the head portions of the fasteners comprises a driving feature with a non-circular cross-section that corresponds to that of a driving tip of the at least one bit.

In some embodiments, the least one bit comprises a first bit configured as a fastener driving bit comprising a driving tip with a non-circular cross-section. In some embodiments, the least one bit comprises a second bit configured as a fastener driving bit comprising a driving tip with a non-circular cross-section that defines a total longitudinal length that differs from that of the first bit. In some embodiments, the least one bit comprises a second bit configured as a drill bit.

In some embodiments, the least one bit comprises a base end a driving portion that defines a non-circular cross-section. In some such embodiments, the base of the at least one bit defines a circular cross-section. In some such embodiments, the base of the at least one bit defines an arcuately convex dome-shaped free end. In some such embodiments, the base of the at least one bit defines a circumferential groove longitudinally spaced from the free end thereof.

It should be appreciated that all combinations of the foregoing aspects and additional concepts discussed in greater detail below (provided such concepts are not mutually inconsistent) are contemplated as being part of the inventive subject matter and to achieve the advantages disclosed herein.

These and other objects, features, aspects and advantages of this disclosure will become apparent from the following detailed description of the various aspects of the disclosure taken in conjunction with the accompanying drawings.

### BRIEF DESCRIPTION OF THE DRAWINGS

These and other features, aspects, and advantages of the present disclosure will become better understood when the following detailed description is read with reference to the accompanying drawings, which are not necessarily drawn to scale and in which like reference numerals represent like aspects throughout the drawings, wherein:

FIG. 1 illustrates, in one example, a front perspective view of a depth setting bit driver in a longitudinally extended engaged driving state, in accordance with one or more aspects of the present disclosure.

FIG. 2 illustrates, in one example, another front perspective view of the depth setting bit driver of FIG. 1 in a longitudinally extended engaged driving state, in accordance with one or more aspects of the present disclosure.

FIG. 3 illustrates, in one example, a front perspective exploded view of the depth setting bit driver of FIG. 1, in accordance with one or more aspects of the present disclosure.

FIG. 4 illustrates, in one example, a front perspective cross-sectional view of a drive member, a drive connector and a drive sleeve of the depth setting bit driver of FIG. 1 in a longitudinally extended engaged driving state, in accordance with one or more aspects of the present disclosure.

FIG. 5 illustrates, in one example, a side cross-sectional view of the depth setting bit driver of FIG. 1 in a longitudinally extended engaged driving state, in accordance with one or more aspects of the present disclosure.

FIG. 6 illustrates, in one example, a side cross-sectional perspective view of the depth setting bit driver of FIG. 1 in a longitudinally retracted disengaged non-driving state, in accordance with one or more aspects of the present disclosure.

FIG. 7 illustrates, in one example, a front perspective view of another depth setting bit driver in a longitudinally extended engaged driving state and a drive sleeve and stop portion thereof illustrated transparently, in accordance with one or more aspects of the present disclosure.

FIG. 8 illustrates, in one example, a front perspective view of the depth setting bit driver of FIG. 7 in a longitudinally retracted disengaged non-driving state and a drive sleeve and stop portion thereof illustrated transparently, in accordance with one or more aspects of the present disclosure.

FIG. 9 illustrates, in one example, a front perspective view of another depth setting bit driver in a longitudinally extended engaged driving state and a drive sleeve and stop portion thereof illustrated transparently, in accordance with one or more aspects of the present disclosure.

FIG. 10 illustrates, in one example, a front perspective view of the depth setting bit driver of FIG. 9 in a longitudinally retracted disengaged non-driving state and a drive sleeve and stop portion thereof illustrated transparently, in accordance with one or more aspects of the present disclosure.

FIG. 11 illustrates, in one example, a front perspective view of another depth setting bit driver in a longitudinally extended engaged driving state and a drive sleeve and stop portion thereof illustrated transparently, in accordance with one or more aspects of the present disclosure.

FIG. 12 illustrates, in one example, a front perspective view of the depth setting bit driver of FIG. 11 in a longitudinally retracted disengaged non-driving state and a drive sleeve and stop portion thereof illustrated transparently, in accordance with one or more aspects of the present disclosure.

FIG. 13 illustrates, in one example, a side cross-sectional view of another depth setting bit driver with resilient material overmolded on an end portion of a stop portion, in accordance with one or more aspects of the present disclosure.

FIG. 14 illustrates, in one example, a front perspective view of another depth setting bit driver in a longitudinally extended engaged driving state, in accordance with one or more aspects of the present disclosure.

FIG. 15 illustrates, in one example, a front perspective exploded view of the depth setting bit driver of FIG. 14, in accordance with one or more aspects of the present disclosure.

FIG. 16 illustrates, in one example, a side cross-sectional view of the depth setting bit driver of FIG. 14 in a longitudinally extended engaged driving state, in accordance with one or more aspects of the present disclosure.

FIG. 17 illustrates, in one example, a side cross-sectional view of another depth setting bit driver in a longitudinally extended engaged driving state, in accordance with one or more aspects of the present disclosure.

FIG. 18 illustrates, in one example, a side cross-sectional view of the depth setting bit driver of FIG. 17 in a longitudinally retracted disengaged non-driving state, in accordance with one or more aspects of the present disclosure.

FIG. 19 illustrates, in one example, a side cross-sectional view of another depth setting bit driver in a longitudinally extended engaged driving state, in accordance with one or more aspects of the present disclosure.

FIG. 20 illustrates, in one example, a side cross-sectional view of the depth setting bit driver of FIG. 19 in a longitudinally retracted disengaged non-driving state, in accordance with one or more aspects of the present disclosure.

FIG. 21 illustrates, in one example, a side cross-sectional view of another depth setting bit driver in a longitudinally extended engaged driving state, in accordance with one or more aspects of the present disclosure.

FIG. 22 illustrates, in one example, a side cross-sectional view of the depth setting bit driver of FIG. 21 in a longitudinally retracted disengaged non-driving state, in accordance with one or more aspects of the present disclosure.

FIG. 23 illustrates, in one example, a side cross-sectional view of another depth setting bit driver in a longitudinally extended engaged driving state, in accordance with one or more aspects of the present disclosure.

FIG. 24 illustrates, in one example, a side cross-sectional view of the depth setting bit driver of FIG. 23 in a longitudinally retracted disengaged non-driving state, in accordance with one or more aspects of the present disclosure.

FIG. 25 illustrates, in one example, a side cross-sectional view of another depth setting bit driver in a longitudinally extended engaged driving state, in accordance with one or more aspects of the present disclosure.

FIG. 26 illustrates, in one example, a side cross-sectional view of the depth setting bit driver of FIG. 25 in a longitudinally retracted disengaged non-driving state, in accordance with one or more aspects of the present disclosure.

FIG. 27 illustrates, in one example, a side perspective view of another depth setting bit driver in a longitudinally retracted disengaged non-driving state, in accordance with one or more aspects of the present disclosure.

FIG. 28 illustrates, in one example, an end perspective view of the depth setting bit driver of FIG. 27, in accordance with one or more aspects of the present disclosure.

FIG. 29 illustrates, in one example, another end perspective view of the depth setting bit driver of FIG. 27, in accordance with one or more aspects of the present disclosure.

FIG. 30 illustrates, in one example, another end perspective view of the depth setting bit driver of FIG. 27, in accordance with one or more aspects of the present disclosure.

FIG. 31 illustrates, in one example, a side exploded view of the depth setting bit driver of FIG. 27, in accordance with one or more aspects of the present disclosure.

FIG. 32 illustrates, in one example, a side exploded perspective view of the depth setting bit driver of FIG. 27, in accordance with one or more aspects of the present disclosure.

FIG. 33 illustrates, in one example, an end exploded perspective view of the depth setting bit driver of FIG. 27, in accordance with one or more aspects of the present disclosure.

FIG. 34 illustrates, in one example, another end exploded perspective view of the depth setting bit driver of FIG. 27, in accordance with one or more aspects of the present disclosure.

FIG. 35 illustrates, in one example, a side exploded perspective view of a drive sleeve and a stop portion of the depth setting bit driver of FIG. 27, in accordance with one or more aspects of the present disclosure.

FIG. 36 illustrates, in one example, another side exploded perspective view of the drive sleeve and the stop portion of the depth setting bit driver of FIG. 27, in accordance with one or more aspects of the present disclosure.

FIG. 37 illustrates, in one example, a side cross-sectional view of the depth setting bit driver of FIG. 27 in its longitudinally retracted disengaged non-driving state, in accordance with one or more aspects of the present disclosure.

FIG. 38 illustrates, in one example, a side cross-sectional perspective view of the depth setting bit driver of FIG. 27 in its longitudinally retracted disengaged non-driving state, in accordance with one or more aspects of the present disclosure.

FIG. 39 illustrates, in one example, a side cross-sectional view of the depth setting bit driver of FIG. 27 in a longitudinally extended engaged driving state, in accordance with one or more aspects of the present disclosure.

FIG. 40 illustrates, in one example, a side cross-sectional perspective view of the depth setting bit driver of FIG. 27 in its longitudinally extended engaged driving state, in accordance with one or more aspects of the present disclosure.

FIG. 41 illustrates, in one example, a side cross-sectional view of the depth setting bit driver of FIG. 27 in a longitudinally extended shallow depth arrangement/setting of its stop portion, in accordance with one or more aspects of the present disclosure.

FIG. 42 illustrates, in one example, a side cross-sectional view of the depth setting bit driver of FIG. 27 in a longitudinally retracted deep depth arrangement/setting of its stop portion, in accordance with one or more aspects of the present disclosure.

FIG. 43 illustrates, in one example, a side cross-sectional view of the depth setting bit driver of FIG. 27 in an unlocked/fixed depth arrangement/setting of its stop portion, in accordance with one or more aspects of the present disclosure.

FIG. 44 illustrates, in one example, a side cross-sectional view of the depth setting bit driver of FIG. 27 in a locked/fixed depth arrangement/setting of its stop portion, in accordance with one or more aspects of the present disclosure.

### DETAILED DESCRIPTION

Aspects of the present disclosure and certain examples, features, advantages, and details thereof, are explained more fully below with reference to the non-limiting examples illustrated in the accompanying drawings. Descriptions of well-known materials, features, aspects, components, fabrication, processing techniques, etc., may be omitted so as not to unnecessarily obscure the relevant details. It should be understood, however, that the detailed description and the specific examples, while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art from this disclosure.

Approximating language, as used herein throughout disclosure, may be applied to modify any quantitative representation that could permissibly vary without resulting in a change in the basic function to which it is related. Accordingly, a value modified by a term or terms, such as “about” or “substantially,” is not limited to the precise value specified. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. In some instances, the approximating language may correspond to the precision of an instrument for measuring the value.

Terminology used herein is for the purpose of describing particular examples only and is not intended to be limiting. As used herein, the singular forms “a”, “an” and “the” are intended to include the plural forms as well, unless the context clearly indicates otherwise. Furthermore, references to “one example” are not intended to be interpreted as excluding the existence of additional examples that also incorporate the recited features. Moreover, unless explicitly stated to the contrary, the terms “comprising” (and any form of “comprise,” such as “comprises” and “comprising”), “have” (and any form of “have,” such as “has” and “having”), “include” (and any form of “include,” such as “includes” and “including”), and “contain” (and any form of “contain,” such as “contains” and “containing”) are used as open-ended linking verbs. As a result, any examples that “comprises,” “has,” “includes” or “contains” one or more step or element possesses such one or more step or element, but is not limited to possessing only such one or more step or element. As used herein, the terms “member” and “portion” may include multiple sub-portions that may be of the same or differing materials, and/or may be a part or fraction of a piece, component or feature or the entirety of the piece, component or feature. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable or suitable. For example, in some circumstances, an event or capacity can be expected, while in other circumstances the event or capacity cannot occur - this distinction is captured by the terms “may” and “may be.”

The present disclosure is directed generally to depth setting bit drivers or depth setters for use with rotary tools, including high powered rotary tools, that couple with a bit to rotate the bit and prevent the bit from penetrating a below a certain distance/depth in a workpiece. The depth setting bit drivers of the present disclosure facilitate precision depth setting for driving screws and/or drilling holes, for example, with a bit (e.g., a driver bit or a drill bit) while preserving the surface of the workpiece. In particular, the depth setting bit drivers of the present disclosure include clutch mechanism that are configured to withstand high torque/rotatory loads, and/or periodic torque/rotatory loads, by preventing wear and deformation of the bearing surfaces thereof to avoid unintentional and/or premature clutch disengagement or a complete failure of the clutch mechanism. The depth setting bit drivers of the present disclosure are also configured to utilize standard widely-available bits, and potentially set fasteners or form apertures to certain pre-determined or specified depths in a workpiece via such bits.

In some embodiments of the present disclosure, the depth setting bit drivers of the present disclosure are adjustable to depth settings selected by the user. In some other embodiments of the present disclosure, the depth setting bit drivers of the present disclosure have a fixed depth limit for a particular bit (e.g., a particular driver bit or a drill bit).

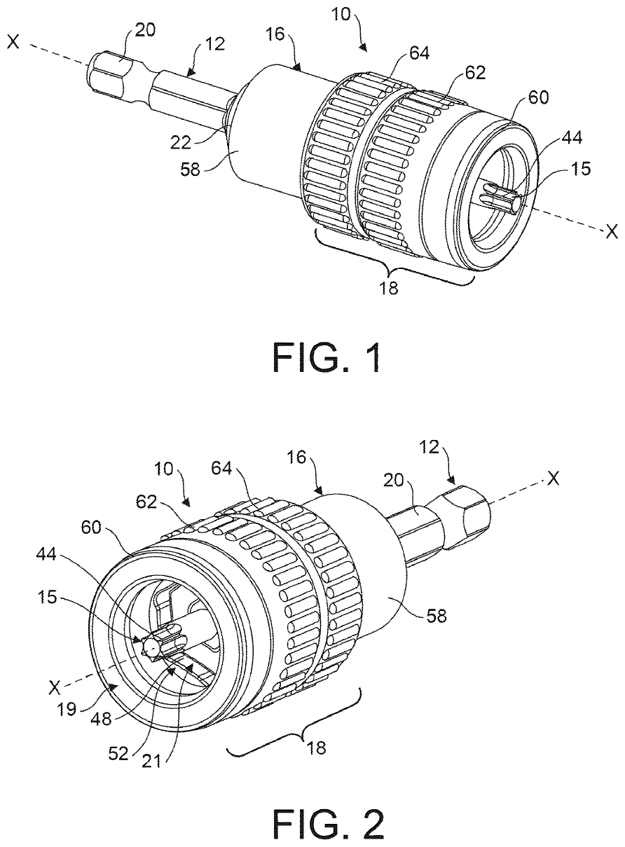

One exemplary embodiment of a depth setting bit driver according to the present disclosure is shown in FIGS. 1-6 and generally referenced by reference numeral 10. The depth setting bit driver 10 is shown in FIGS. 1-3, 5 and 6 being removably coupled with an exemplary bit 15. The depth setting bit driver 10 and the bit 15 may, together, form a tool construct (such as a rotary tool), system or kit, or a rotary tool attachment, configured to be torqued and worked directly or indirectly on a workpiece (e.g., drive a fastener into the workpiece, or form an aperture in the workpiece).

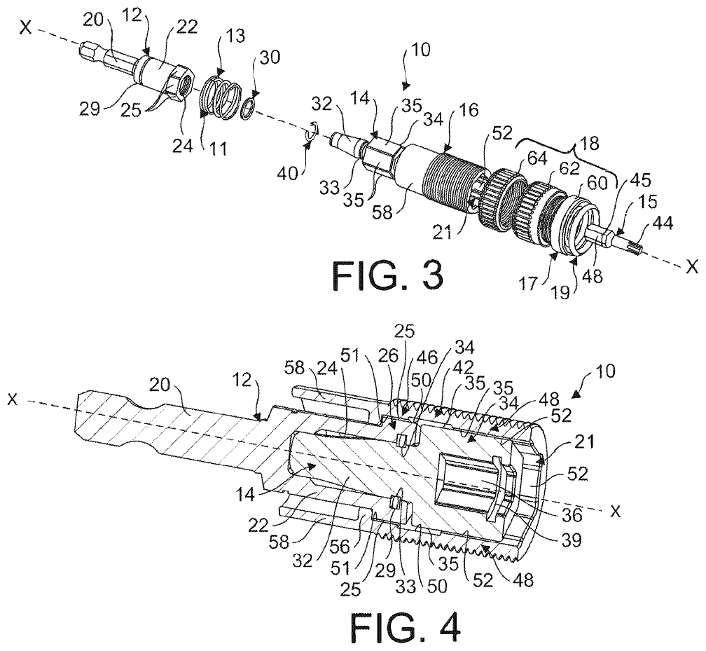

As further discussed below, the depth setting bit driver 10 is configured to removably couple with the bit 15. In some embodiments, the bit 15 may be a standardized driver bit configured to rotatably drive/torque a fastener, screw, bolt, anchor, adapter, socket, or the like (collectively referred to herein as a “fastener”). In some other embodiments, the bit 15 may be configured as a drill bit or the like configured to form a hole or otherwise remove material of a workpiece. As shown in FIGS. 3, 4 and 5, the bit 15 may include a shaft or shank 42, and a bit retention cavity 36 the depth setting bit driver 10 may be configured to accept and mate with the shank 42 rotatably drive/torque the bit 10 (as explained further below

The shank 42 of the bit 15 may typically define a non-circular cross-section (taken perpendicular to the longitudinal axis X-X of the shank 42 and the driver 10) for the application of the rotational/torque load/forces applied thereto. For example, the shank 42 of the bit 15 (and potentially the bit retention cavity 36) may define a hexagonal, octagonal or other similar shape with circumferentially-arranged bearing surfaces (e.g., two-dimensionally extended bearing surfaces, which may be flat bearing surfaces) that are configured to accept a rotational force/torque to rotate the bit 15. In some embodiments, the shank 42 of the bit 15 may define a standard ¼ inch hexagonal shank (and potentially the bit retention cavity 36 may be correspondingly shaped) that is configured to fit within into standard drills with either a keyed, keyless, or ¼ inch (6.35 mm) hex drive chuck. In some embodiments, the shank 42 of the bit 15 (and potentially the bit retention cavity 36) (or the entirety of the bit 15) may define an axial or longitudinal length within the range of about 3 mm and about 100 mm, or about 3 mm and about 75 mm, or about 3 mm and about 50 mm, or about 5 mm and about 25 mm, or about 5 mm and about 15 mm.

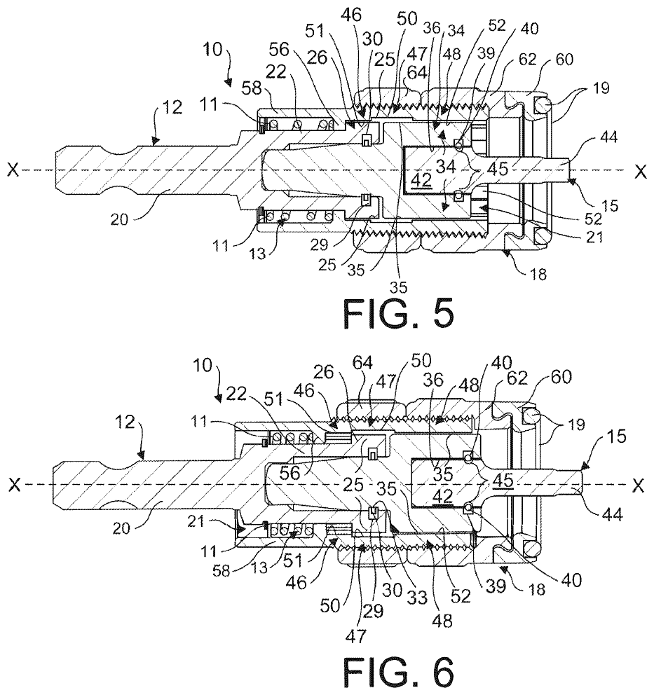

As discussed further below, the bit retention cavity 36 of the driver 10 may include a feature that removably couples or secures the shank 42 of the bit 15 therein. In some embodiments, to facilitate such a removable coupling of the bit 15 within the bit retention cavity 36, the shank 42 of the bit 15 may include a recess or slot 45, as shown in FIGS. 3, 5 and 6. The recess 45 may be a circumferential peripheral recess that extends partially or fully about the shank 42. The recess 45 may be configured to accept a retention member 40, such as a resilient or elastic retaining ring, washer, shim, pin or the like (or a combination thereof), therein to removably couple the bit 15 within the bit retention cavity 36, as shown in FIGS. 5 and 6. As also shown in FIGS. 5 and 6, the retention member 40 may be retained in an inner slot or recess 39 of the bit retention cavity 36 of the driver 10 that is substantially similar to the recess 45. The shank 42 of the bit 15 may thereby be longitudinally translated into the bit retention cavity 36 and along the retention member 40 (potentially elastically deforming (e.g., expanding) the retention member 40) until the retention member 40 seats within the recess 45, as shown in FIGS. 5 and 6. In some other embodiments, the drive coupler 13 forming the retention cavity 36 may include a magnet or other mechanism for removably coupling/retaining the bit 15 in the retention cavity 36.

In some embodiments, the bit 15 may include a driving portion or tip 44 extending form the shank 42, as shown in FIGS. 1-3, 5 and 6. The driving portion or tip 44 of the bit 15 may define a longitudinal distal free end of the bit 15. The driving portion 44 may be configured to drive (i.e., rotate/torque) a fastener into a workpiece (as shown in FIGS. 1-3, 5 and 6) or to drill or otherwise form a hole in the workpiece (not shown). For example, as shown in FIGS. 1-3, 5 and 6, the driving portion 44 may define a non-circular cross-section configured to engage a corresponding or mating driving feature of a fastener (not shown) such that the fastener and the bit 15 are rotationally fixed/locked. In some embodiments, the driving feature may be formed or provided on/in a head portion of the fastener, and/or a fastener may include an externally-threaded shaft portion extending longitudinally from the head portion. The driving portion 44 of the bit 15 may drivingly engage the driving portion of a fastener so that the bit 15 rotates/torques the fastener (via the driver 10 in a driving arrangement/state thereof, and a rotary device rotating/torquing the driver 10). In some embodiments, the driving portion or tip 44 may be configured as a standardized fastener configured to drive fasteners with standardized driving features. For example, the shape/configuration of the driving portion or tip 44 of the bit 15 may be configured such that the bit 15 is configured as a Philips bit, posidrive bit, slotted bit, Torx® bit, tamperproof Torx® bit, internal hex bit, square recess bit, nutsetter bit, drywall bit, torq bit, tri-wing bit, spanner bit, tri-lobular bit, spider bit, socket adaptor, bolt extractor or other commercially available or known driver bit configuration.

It is noted that the driver 10 may be utilized with bits 15 of differing lengths to customize the depth in which the driving portion or tip 44 of the bit 15 is driven into a workpiece via the driver 10 (as further discussed below). Further, the driver 10 may be utilized with bits 15 of differing configurations, as discussed above. Accordingly, a kit or system according to the present disclosure may include at least one driver 10 (i.e., only a single driver 10, or a plurality of drivers 10) and at least one bit 15 (e.g., only a single bit 15, or a plurality of bits 15), such as two or more bits of differing total longitudinal lengths (between the longitudinal ends thereof) and/or driving tip 44 configurations. Similarity, a kit or system according to the present disclosure may include at least one driver 10, at least one bit 15 and a plurality of fasteners, the at least one bit 15 and the plurality of fasteners being configured to drivingly mate via the driving portion 44 and the driving features thereof as described above.

As shown in FIGS. 1-6 the depth setting bit driver 10 is configured to be rotated or torqued about a longitudinal axis of rotation X-X (referred to the longitudinal axis, axis of rotation, or the like herein) via a rotary device/tool to, in turn, rotate/torque the bit 15 about the axis X-X in a longitudinally extended engaged (or driving) arrangement (or state or configuration) of the depth setting bit driver 10. The driver 10 may define the longitudinal axis X-X, and the components/portions of the driver 10 may be formed annularly or circumferentially thereabout (e.g., substantially evenly or consistently annularly thereabout). The driver 10 may define the longitudinal axis X-X, and be extended/elongated along the longitudinal axis X-X, as shown in FIGS. 1-3, 5 and 6.

The construct of the depth setting bit driver 10 and the bit 15, in a longitudinally extended engaged arrangement of the driver 10, is configured to rotate about the axis X-X, as shown in FIG. 5. The depth setting bit driver 10 is also configured to rearrange from the longitudinally extended engaged driving arrangement to a longitudinally retracted disengaged (or non-driving) arrangement (or state or configuration), as shown in FIGS. 5 and 6. In the longitudinally retracted disengaged arrangement, while remaining coupled with the bit 10 (and a longitudinal free end of the drive 10 in contact with a workpiece), the driver 10 is configured to rotate about the axis X-X but not transfer such rotation/torque to the bit 10, as shown in FIG. 6. Further, when in the longitudinally retracted disengaged arrangement, the driver 10 is configured to not transfer such rotation/torque to a drive connector portion 14, a drive sleeve portion 16 and a stop portion 18 coupled to the drive sleeve 16 that defines the longitudinal free end of the drive 10 for contacting/engaging a workpiece (other than via minor frictional forces), as explained further below, as shown in FIG. 6.

Accordingly, when a drive spindle 20 of a drive member 12 of the driver 10 is rotated/torqued about the axis X-X, such as via a rotary tool or other device, and the driver 10 is in the longitudinally retracted disengaged arrangement (and a longitudinal free end of the drive 10 in contact with a workpiece) as shown in FIG. 6, the drive member 12 is rotated about the axis X-X, but the driver 10 does not transfer such rotation/torque to the bit 10 (nor the drive connector portion 14, the drive sleeve portion 16 and the stop portion 18). The drive spindle 20 may be engaged with a rotary device and a torque/rotational force applied thereto. In the disengaged state, as shown in FIG. 6, the bit driver 10 is thereby not drivingly engaged with the bit 15 such that the rotary load/force applied to the drive member 12 is transferred and applied to the bit 15. In this way, when the bit driver 10 is in the disengaged state and a workpiece engagement portion 19 of the bit driver 10 is in engagement with a workpiece, rotation or torque applied to the drive member 12 (specifically the drive spindle 20 thereof) of the depth setting bit driver 10 does not cause the bit 15 to rotate about the axis X-X. Conversely, when the driver 10 is in the longitudinally extended engaged driving arrangement, as shown in FIG. 5, which the drive 10 may be naturally or normally biased into, the drive member 12 is drivingly coupled (i.e., rotationally fixedly coupled or locked) with the drive connector 14 via the drive sleeve 16, and as the bit 15 is drivingly engaged within the bit retention cavity 36 of the drive connector 14, the drive member 12 is drivingly coupled with the bit 15 such that the rotary load/force applied to the drive member 12 is transferred and applied to the bit 15. The longitudinally extended engaged driving arrangement and the longitudinally retracted disengaged non-driving arrangement differ in the longitudinal telescopic arrangement of the drive sleeve 16 and the drive member 12, and specifically a first bearing portion 46 of the drive sleeve 16 and a bearing portion 26 of the drive member 12, as shown in FIGS. 5 and 6.

The depth setting bit driver 10 is configured such that the bit 15 extends past/from a driving or workpiece distal end of the driver 10 a first distance or depth in the engaged state, and such that the bit 15 extends past/from the distal end a second distance or depth in the disengaged state that is greater/deeper than the first distance or depth. In this way, the longitudinal length of the driver 10 and the arrangement thereof may be varied or changed by longitudinally pressing the driving or workpiece distal end of the driver 10 (defined by a stop portion 18 longitudinally fixed to the drive sleeve 16) against a workpiece via the drive spindle 20 to force the drive sleeve 16 to longitudinally translate over the bearing portion 26 of the drive member 12 until the bit 15 reaches the second depth into/within a workpiece, at which arrangement/configuration the depth setting bit driver 10 transitions from the engaged state to the disengaged state to set/stop the tip of the bit 15 from rotating (and potentially a head of a fastener engaged therewith) at the second depth and prevent further translation of the bit 15 (and potentially the head of the fastener engaged therewith) deeper into the workpiece via rotation thereof. In some embodiments, the difference between the first and second longitudinal distances/depths is within the range of about 1 mm and about 20 mm, or about 2 mm and about 15 mm, or about 2 mm and about 10 mm, or about 2 mm and about 8 mm.

As shown in FIGS. 1-6, the drive member 12 comprises a drive spindle portion 20 and a drive body portion 22. The drive body 22 includes an inner adapter cavity 24 and a bearing portion that defines or otherwise includes a plurality of external circumferentially-arranged first bearing surfaces 25 that are extended along two-dimensions (e.g., extended longitudinally and a second direction, such as a direction extending at an angle (e.g., perpendicular) thereto). In some embodiments, the drive body 22 extends longitudinally from the drive spindle 12. In some embodiment, the adapter cavity 24 extends longitudinally into the drive body 22 from a longitudinal end of the drive body 12 toward the spindle 20. The bearing portion, and the first bearing surfaces 25, may extend longitudinally from the longitudinal end of the drive body 24 (and the drive member 12). The spindle 12 may define a longitudinal end of the driver 10.

The drive body 22 may be substantially cylindrical or annular, and define differing radial widths along its longitudinal length. For example, the bearing portion of the drive body 22 may define a larger cross-sectional, lateral or radial size/width than adjacent portion of the drive body 22. As shown in FIGS. 4-6, the inner adapter cavity 24 and the spindle 20 may be aligned on the axis X-X, and the adapter cavity 24 may be open at the distal longitudinal end of the dive body 22 (and the drive member 12).

As also shown in FIGS. 4-6, the drive connector 14 comprises a coupling portion 32 that extends longitudinally into, and thereby housed in, the adapter cavity 24. The adapter cavity 24 and the coupling portion 32 may be configured such that the coupling portion 32 is aligned on the axis X-X, and is free to rotate about the axis X-X, but prevented from laterally/radially shifting therein. Further, the adapter cavity 24 and the coupling portion 32 are configured such that the coupling portion 32 is longitudinally fixed within the adapter cavity 24 such that the drive member 12 and the drive connector 14 are rotationally coupled and longitudinally fixed together. In some embodiments, the inner bit retention cavity 24 defines a non-circular cross-section and is configured to retain and engage the driving shank/stem 42 of the bit 15 (that defines a non-circular cross-section) such that the drive connector 14 and the bit 15 are rotationally fixed (when the driving shank/stem 42 is positioned within the bit retention cavity 24). In some embodiments, the adapter cavity 24 includes a partially or fully annular coupling groove or recesses 29, and the coupling portion 32 includes a partially or fully annular coupling groove or recess 33 that longitudinally align align when the coupling portion 32 is seated within the adapter cavity 24. In such embodiments, the coupling portion 32 and the adapter cavity 24 are rotationally coupled and longitudinally fixed via a retaining member, ring, washer, shim, pin or the like 30 (or a combination thereof) extending within the coupling recesses 29, 33, as shown in FIGS. 4-6.

The drive connector 14 may also comprise a bearing, drive or connector portion 34 longitudinally distal to the coupling portion 32. The bearing portion 34 may extend from the coupling portion 32, and may define a larger cross-sectional, lateral or radial size/width than the coupling portion 32. The bearing portion 34 may define a lateral end portion of the coupling portion 32. As shown in FIGS. 2 and 4-6, the bearing portion 26 of the drive connector 14 may define or include the inner bit retention cavity 36 (of a non-circular cross-section) to drivingly engage and retain a shank 42 of the bit 15 therein. The bit retention cavity 36 may be formed via an inner cavity extending longitudinally within the bearing portion 34 from the longitudinal free end of the bearing portion (and the drive connector 14).

As shown in FIGS. 2-6, the bearing portion 34 of the drive connector 14 may also define or otherwise include a plurality of external circumferentially-arranged second bearing surfaces 35 that are extended along two-dimensions (e.g., extended longitudinally and a second direction, such as a direction extending at an angle (e.g., perpendicular) thereto). The first bearing surfaces 25 of the drive member 12 and the second bearing surfaces 35 of the drive adapter 14 are configured to drivingly engage corresponding bearing surfaces 51, 52 of the drive sleeve 16 in the engaged arrangement/state of the driver 10 such that the drive member 12, the drive adapter 14 and the drive sleeve 16 are rotationally fixed or locked (about the longitudinal axis X-X), as discussed further below. In the disengaged arrangement/state of the driver 10, at least one of the first bearing surfaces 25 of the drive member 12 and the second bearing surfaces 35 of the drive adapter 14 do not engage the bearing surfaces 51, 52 of the drive sleeve 16 such that the drive member 12 is rotationally free/unlocked from the drive adapter 14 and the drive sleeve 16.

Accordingly, drive sleeve 16 may include an inner longitudinal drive cavity 21 in which at least the bearing portion 26 of the drive member 12 and the bearing portion 34 of the drive adapter 20 telescopingly extend within. In some embodiments, the drive cavity 21 may extend entirely longitudinally through the drive sleeve 16 between longitudinal free ends thereof. As shown in FIGS. 4-6, the drive cavity 21 may define or include a disengagement portion 47 with non-bearing internal surfaces 50 and a clutch portion comprising at least one drive portion 46, 48 with a plurality of internal circumferentially-arranged third bearing surfaces 51, 52 that are extended along two directions. In some embodiments, the non-bearing internal surfaces 50 of the disengagement portion 47 define a larger opening within the drive cavity 21 than an opening within the drive cavity 21 defined by the third bearing surfaces 51, 52 of the at least one drive portion 46, 48 of the clutch portion.

As discussed above, the drive sleeve 16 is telescopingly coupled with the drive member 12 and the drive connector 14 between the longitudinally extended engaged arrangement and the longitudinally retracted disengaged arrangement with respect thereto. As shown in FIGS. 4 and 6, in the longitudinally extended engaged arrangement, the first and second bearing surfaces 25, 35 are in engagement with the third bearing surfaces 51, 52 to rotationally lock the drive member 12 and the drive connector 14 via the drive sleeve 16. As shown in FIG. 5, in the longitudinally retracted disengaged arrangement, one of the first bearing surfaces 25 are positioned within the disengagement portion 47 of the drive cavity to rotationally unlock the drive member 12 and the drive connector 14. In such an arrangement in the longitudinally retracted disengaged arrangement, the first bearing surfaces 25 are thereby positioned within the disengagement portion 47 of the drive cavity 21 and radially spaced from the non-bearing internal surfaces 50 the disengagement portion 47, as shown in FIG. 5.

As shown in FIG. 6, in the longitudinally retracted disengaged arrangement, the second bearing surfaces 34 are in engagement with the third bearing surfaces 52 to rotationally lock the drive connector 14 and the drive sleeve 16, and the first bearing surfaces 25 are positioned within the disengagement portion 47 of the drive cavity 21 of the drive sleeve 16 to rotationally unlock the drive member 14 and the drive sleeve 16. In some such embodiments, the clutch portion of the drive cavity 21 comprises a first drive/clutch portion 46 with a first set of bearing surfaces 51 of the third bearing surfaces, and a second drive/clutch portion 48 with a second set of bearing surfaces 52 of the third bearing surfaces, and the disengagement portion 47 with the non-bearing surfaces 50 positioned longitudinally between the first and second drive/clutch portions 46, 48. In such embodiments, in the longitudinally retracted disengaged arrangement, the second bearing surfaces 35 are in engagement with the second set of bearing surfaces 52 of the third bearing surfaces to rotationally lock the sleeve 16 and the adapter 114, as shown in FIG. 6. In the longitudinally elongated engaged arrangement, as shown in FIG. 5, the first bearing surfaces 25 are in engagement with the first set of bearing surfaces 51 of the third bearing surfaces, and the second bearing surfaces 35 are in engagement with the second set of bearing surfaces 52 of the third bearing surfaces.

As discussed above, the first and second bearing surfaces 25, 35 are configured to drivingly engage with the third bearing surfaces 51, 52 when the sleeve portion 16 is longitudinally arranged with the drive member 12 and drive adapter 14 in the driving arrangement with the first and second bearing surfaces 25, 35 longitudinally aligned/overlapping with the third bearing surfaces 51, 52, as shown in FIG. 5. In some embodiments, the first, second and third bearing surfaces 25, 35, 51, 52 are correspondingly shaped, sized and configured. In some embodiments, the first, second and/or third bearing surfaces 25, 35, 51, 52 are extended longitudinally. In some such embodiments, the first, second and/or third bearing surfaces 25, 35, 51, 52 may be extended along a lateral direction that extends perpendicular to the longitudinal axis. For example, the lateral direction may extends radially from the longitudinal axis X-X, or perpendicular to the axis X-X and a radial direction that extends radially from the longitudinal axis X-X. In some embodiments, the first, second and third bearing surfaces 25, 35, 51, 52 (or one or a combination thereof) extend longitudinally, and may or may not be oriented parallel to the longitudinal axis as they extend longitudinally.

In some embodiments, the first, second and third bearing surfaces 25, 35, 51, 52 (or one or a combination thereof) comprise flat surfaces. In some embodiments, the first, second and third bearing surfaces 25, 35, 51, 52 (or one or a combination thereof) comprise arcuate surfaces. In some embodiments, the first, second and third bearing surfaces 25, 35, 51, 52 (or one or a combination thereof) comprise rectilinear surfaces. In some embodiments, the first and second bearing surfaces 25, 35 are formed on or via radially outer sides or surfaces of the bearing portion 26 and the bearing portion 34, respectively. In some embodiments, the third bearing surfaces 51, 52 are formed on or via radially inner sides or surfaces of the at least one drive portion 46, 48.

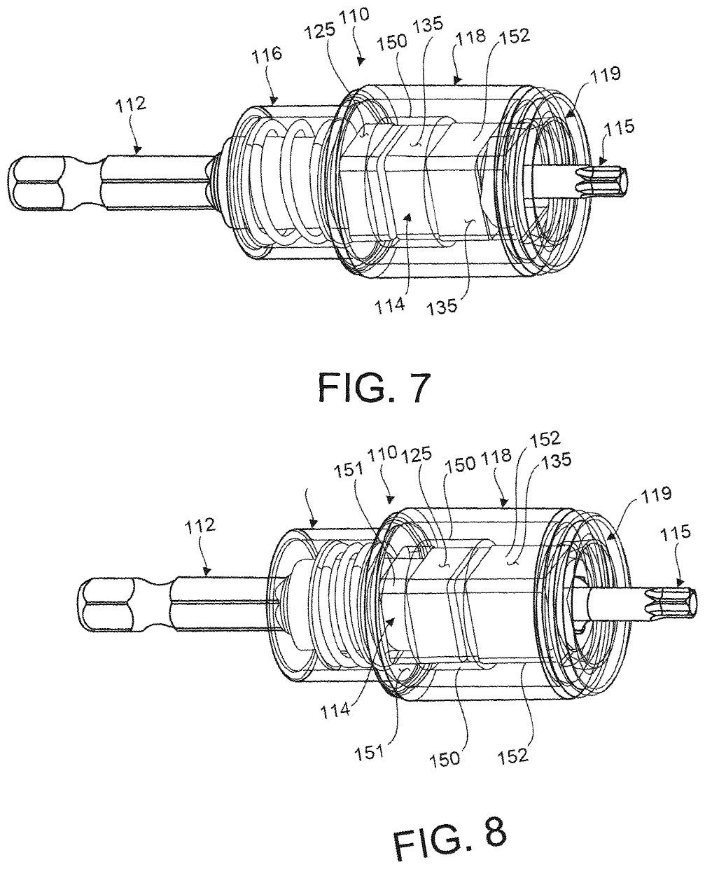

In some embodiments, the first, second and third bearing surfaces 25, 35, 51, 52 may define or form a non-circular cross-sectional shape or arrangement. For example, as shown in FIGS. 3-6, the first, second and third bearing surfaces 25, 35, 51, 52 may form a hexagonal shape or arrangement. It is noted that the first, second and third bearing surfaces 25, 35, 51, 52 (or one or a combination thereof) may define a differing shape or arrangement. For example, the second and/or third bearing surfaces 25, 35, 51, 52 may form a pentagonal, heptagonal, octagonal, decagonal, or irregular rectilinear or arcuate (or a combination thereof) non-circular shape or arrangement. For example, an exemplary alternative embodiment of a bit driver 110 is illustrated FIGS. 7 and 8. The depth setting bit driver 110 is substantially similar to the depth setting bit driver 10, and therefore like reference numerals preceded with “1” are used to indicate like components, aspects, functions or features, and the description above directed to thereto equally applies, and is not repeated for brevity and clarity purposes. As shown in FIGS. 7 and 8, driver 110 differs from depth setting bit driver 10 in that the first, second and third bearing surfaces 125, 135, 151, 152 are configured in rectangular shape or arrangement, as opposed to a hexagonal shape or arrangement.

In some embodiments, the first, second and/or third bearing surfaces 25, 35, 51, 52 may extend parallel to the axis X-X as they extend longitudinally. In some embodiments, the first, second and/or third bearing surfaces 25, 35, 51, 52 may extend from the same longitudinal extent/position, and/or to the same longitudinal extent/position, as they extend longitudinally. In some embodiments, the first, second and/or third bearing surfaces 25, 35, 51, 52. However, the first, second and/or third bearing surfaces 25, 35, 51, 52 may be otherwise configured, such as not extending perpendicular to the axis X-X as they extend longitudinally, not extending from the same longitudinal extent/position, not extending to the same longitudinal extent/position, not being formed via outer peripheral/radial surfaces, etc.

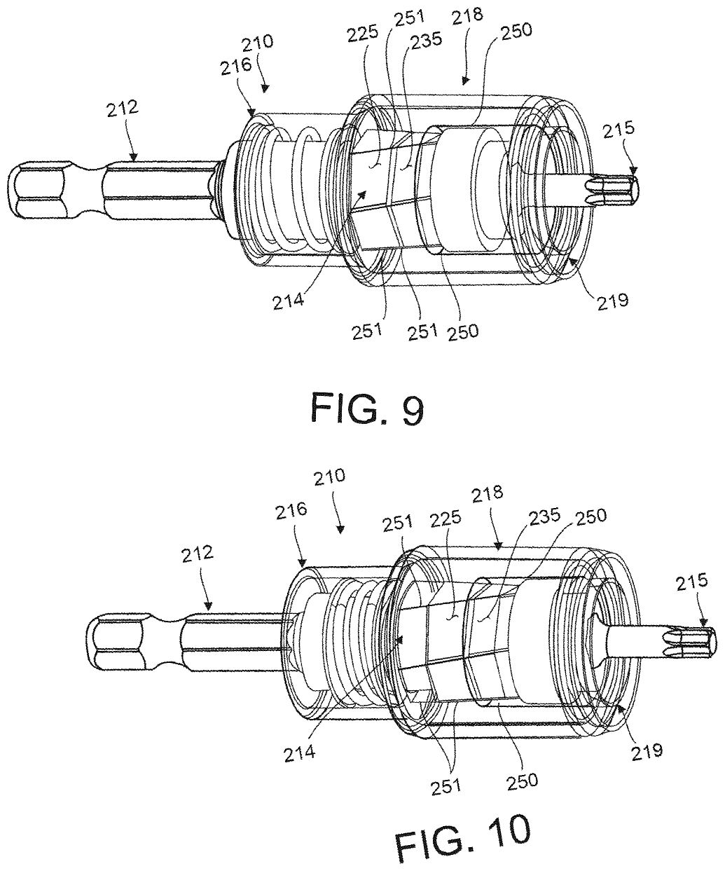

For example, another exemplary alternative embodiment of a bit driver 210 is illustrated FIGS. 9 and 10. The depth setting bit driver 210 is substantially similar to the depth setting bit driver 10 and the depth setting bit driver 110, and therefore like reference numerals preceded with “2” are used to indicate like components, aspects, functions or features, and the description above directed to thereto equally applies, and is not repeated for brevity and clarity purposes. As shown in FIGS. 9 and 10, driver 210 differs from depth setting bit driver 10 depth setting bit driver 110 in that the first, second and third bearing surfaces 225, 235, 251 are configured in a helical shape or arrangement. The first, second and/or third bearing surfaces 225, 235, 251 may be angled radially as they extend longitudinally and/or laterally thereto, and thereby not oriented parallel to the axis X-X. In some embodiments, the first, second and/or third bearing surfaces 225, 235, 251 may extend from differing longitudinal extents/positions (as they extend annularly), and/or extend to differing longitudinal extents/positions (as they extend annularly).

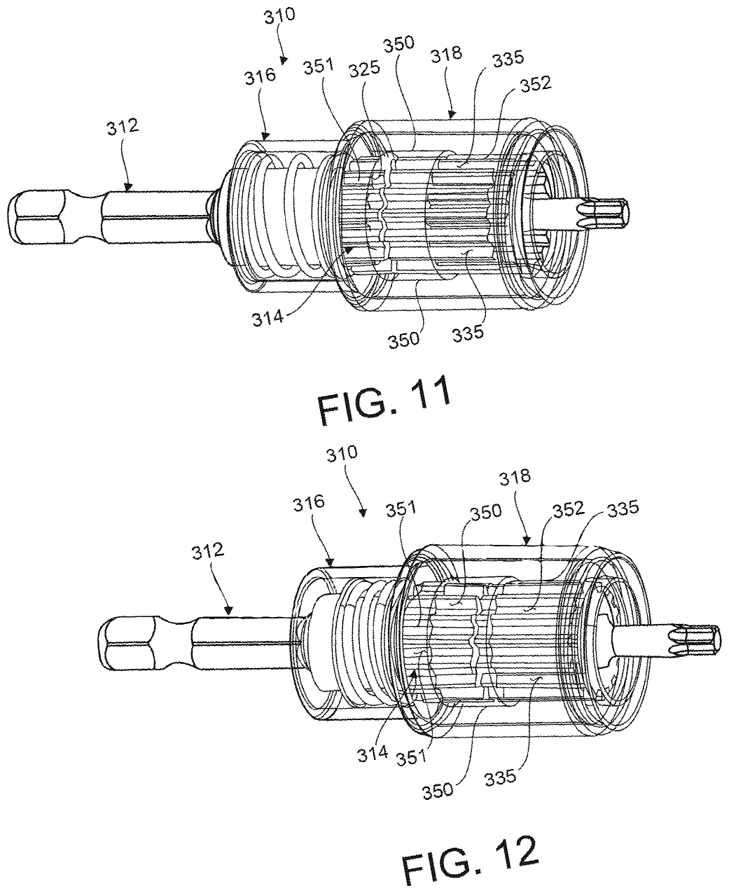

As a further example, another exemplary alternative embodiment of a bit driver 310 is illustrated FIGS. 11 and 12. The depth setting bit driver 310 is substantially similar to the depth setting bit driver 10 and the depth setting bit driver 110, and therefore like reference numerals preceded with “3” are used to indicate like components, aspects, functions or features, and the description above directed to thereto equally applies, and is not repeated for brevity and clarity purposes. As shown in FIGS. 11 and 12, driver 310 is differs from depth setting bit driver 10, depth setting bit driver 110 and depth setting bit driver 210 in that the first, second and third bearing surfaces 325, 335, 351, 352 are formed via a spline arrangement, configuration or coupling. As shown in FIGS. 11 and 12, the first bearing surfaces 325 are formed of radially-extending lateral side surfaces of external first spline features (e.g., spline projections/teeth or spline grooves/channels) of the bearing portion 326, the second bearing surfaces 335 are formed of radially-extending lateral side surfaces of external second spline features (e.g., spline projections/teeth or spline grooves/channels) of the bearing portion 334, and the third bearing surfaces 351, 352 are formed of radially-extending lateral side surfaces of internal third spline features (e.g., spline projections/teeth or spline grooves/channels) of the at least one drive portion 46, 48 of the clutch portion of the inner longitudinal drive cavity 21.

As noted above, the first bearing portion 26 may be located at an end portion of the drive body portion 22, which may be retained within the drive cavity 21. In some such embodiments, the drive cavity 21 of the drive sleeve 16 may include a neck portion 56 and a bias portion 58, the neck portion 56 being positioned longitudinally between the bias portion 58 and the first bearing/drive portion 46 (and the disengagement portion 47), as shown in FIGS. 4-6. The neck portion 56 may define an opening within the drive cavity 21 that is smaller (cross-sectional size/width being less) than the first bearing portion 26, and the narrow portion of the body portion 22 extending from the first bearing portion 26 may extend through the opening of the neck portion 56, as shown in FIGS. 4-6. In this way, the first bearing portion 26 may be longitudinally trapped or stopped from passing longitudinally past the neck portion 56 toward the spindle 20, and thereby trapped/retained in the clutch/drive portion of the drive cavity 21.

In some embodiments, the driver 10 may include a resilient member 13 extending within the opening of the bias portion 58 of the drive cavity 21 longitudinally between the neck portion 56 and a retaining member 11 coupled to the drive body 22 (or spindle 20) in a resiliently deformed state (e.g., resiliently compressed) such that the resilient member 13 exerts a biasing force against the neck portion 56 that biases the drive sleeve 16 into the longitudinally extended engaged arrangement (i.e., longitudinally away from the spindle 20 and toward the first bearing portion 26, the drive adapter 114 and the bit 15), as shown in FIG. 5. In some embodiments, the drive sleeve 16 is naturally or normally biased into the longitudinally extended engaged arrangement via the resilient member 13. In some embodiments, the retaining member 11 may extend or be retained in a groove in the outer surface of the drive body 22 (or spindle 20). In some embodiments, the retaining member 11 may be a resilient or elastic retaining ring, washer, shim, pin or the like (or a combination thereof). It is noted that the drive sleeve 16 may be biased into the longitudinally extended engaged arrangement via other configurations than the illustrated resilient member 13 configuration.

As shown in FIGS. 1-3, 5 and 6, the driver 10 includes a stop portion 18 rotationally coupled to the drive sleeve 16. The stop portion 18 may be configured as a stop sleeve member that extends circumferentially about a distal longitudinal portion of the drive sleeve 16, and radially over a distal longitudinal free end of the drive sleeve 16, as shown in FIGS. 1-3, 5 and 6.

In some embodiments, the stop portion 18 comprises a longitudinal free end portion 60 configured to engage a workpiece, as shown FIGS. 1-3, 5 and 6. In some embodiments, the longitudinal end portion 60 comprises a resilient material 19 that defines a longitudinal free end of the driver 10 coupled thereto such that the resilient material 19 is configured to engage a workpiece during use of the driver 10. For example, the resilient material 19 may be coupled to a longitudinal end portion of the stop sleeve member 60. In some such embodiments, the resilient material 19 may be pressed or forced into/onto a groove in the longitudinal end of the end portion 60 such that a longitudinal end portion of the resilient material 19 is exposed and forms or defines the longitudinal free end of the driver 10. In some embodiments, the resilient material 19 may be an o-ring or like configuration.

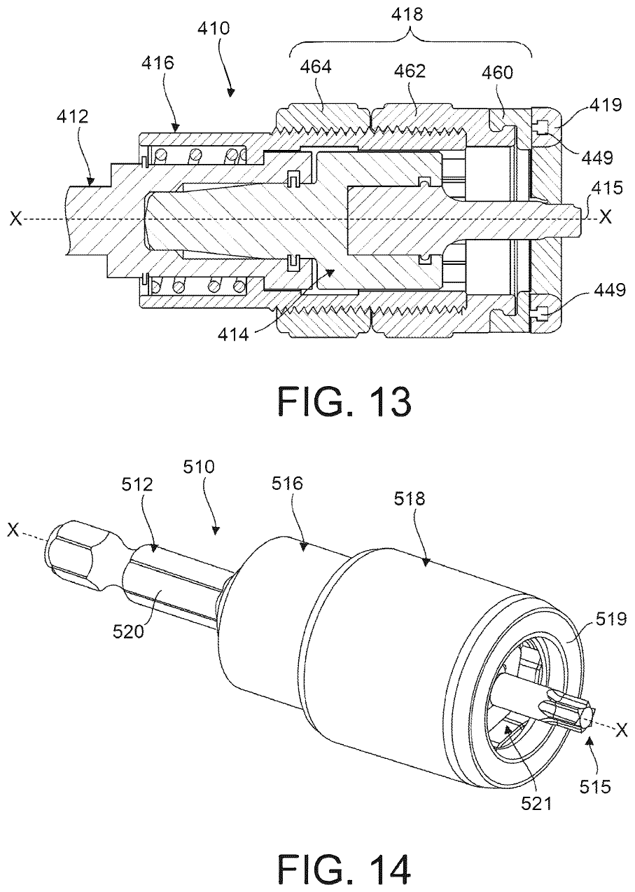

However, the resilient material 19 may otherwise be coupled with the end portion 60 such that it defines a longitudinal free end of the driver 10. For example, an exemplary alternative embodiment of a bit driver 410 is illustrated FIG. 13. The depth setting bit driver 410 is substantially similar to the depth setting bit driver 10, and therefore like reference numerals preceded with “4” are used to indicate like components, aspects, functions or features, and the description above directed to thereto equally applies, and is not repeated for brevity and clarity purposes. As shown in FIG. 13, driver 410 differs from depth setting bit driver 10 in that the longitudinal end of the end portion 460 includes a projection 449, and the resilient material 419 is coupled over the projection 449. For example, the resilient material 419 may be overmolded over the projection 449. As another example, the resilient material 419 may include a groove or slot that accepts the projection 449 therein in a friction or secure coupling manner. As shown in FIG. 13, in some embodiments, the resilient material 419 and the end portion 460 may be configured such that the resilient material 419 extends from the longitudinal extent of the end portion 460. As also shown in FIG. 13, in some embodiments, the outer radial/peripheral sides of the resilient material 419 may be exposed. In some embodiments, the resilient material 419 may extend to the radial outermost edge of the end portion 460 that is longitudinally adjacent to the resilient material 419. For example, the end portion 460 may not include an outer peripheral/radial wall or portion that extends longitudinally and radially over the outer peripheral/radial sides of the resilient material 419. The end portion 460 of the stop sleeve member 418 may not extend radially peripherally over the resilient material 419. In such an embodiment, the base of the resilient material 419 may extend peripherally/radially to the outermost peripheral/radial edge of the end portion 460.

As shown in FIGS. 1-3, 5 and 6, the stop portion 18 may be rotationally and longitudinally-adjustably coupled to the drive sleeve 16, such as over the exterior thereof via a threaded engagement. In some such embodiments, the stop portion 18 may include a depth adjustment member 62 threadably coupled with the drive sleeve 18 such that the first depth adjustment member 62 is threadably longitudinally movable along the drive sleeve 18 to adjust the longitudinal position of the end portion 60 (i.e., the longitudinal free end of the stop portion 18, and thereby the longitudinal driver 10), as shown in FIGS. 1-3, 5 and 6. In some embodiments, the end portion 60 is rotationally coupled and longitudinally fixed to the depth adjustment member 62, as shown in FIGS. 5 and 6.

In some embodiments, the stop portion 18 further comprises a locking member 64 threadably coupled with the drive sleeve 16 longitudinally adjacent to the depth adjustment member 62. The locking member 64 may be threadably longitudinally movable along the drive sleeve 16 such that it can be positioned into longitudinal abutment (and potentially exert a force thereon, as a jam nut) with the depth adjustment member 62. In such an arrangement, the locking member 64 will prevent rotational movement, and thereby and longitudinal translation, of the depth adjustment member 62 to set or fix the longitudinal of the driver 10, and thereby the depth of the bit 15 where the driver 10 is rearranged into the disengaged state.

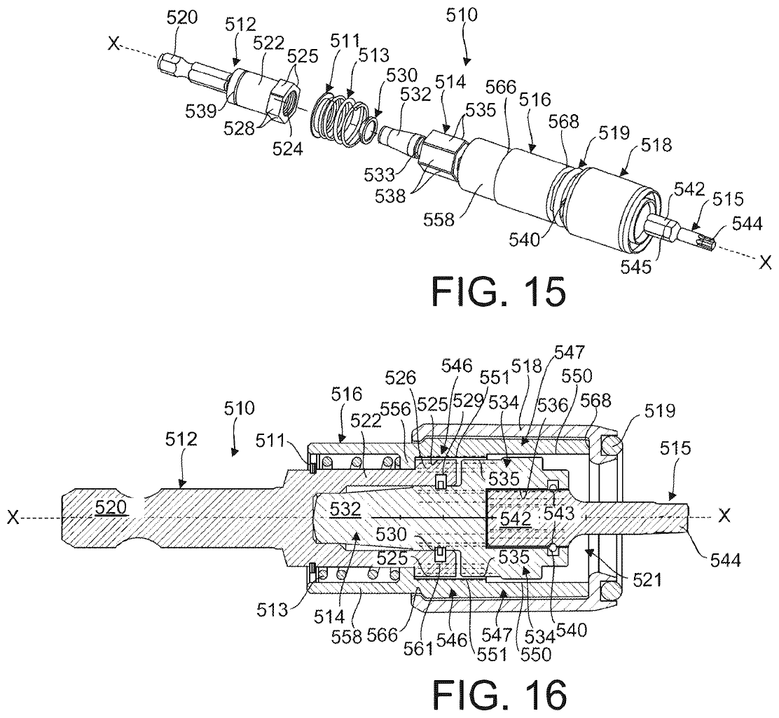

Another exemplary depth setting bit driver 510 according to present disclosure is shown in FIGS. 14-16. The depth setting bit driver 510 is substantially similar to the depth setting bit driver 10, the depth setting bit driver 110, the depth setting bit driver 210, the depth setting bit driver 310 and the depth setting bit driver 410, and therefore like reference numerals preceded with “5” are used to indicate like components, aspects, functions or features, and the description above directed to thereto equally applies, and is not repeated for brevity and clarity purposes.

As shown in FIGS. 14-16, in one aspect, the driver 510 differs from the depth setting bit driver 10, the depth setting bit driver 110, the depth setting bit driver 210, the depth setting bit driver 310 and the depth setting bit driver 410 in the configuration of the stop sleeve 518. As shown in FIGS. 14-16, the stop portion 518 is rotationally coupled and longitudinally fixed to the drive sleeve 516, and configured as a fixed or non-adjustable longitudinal length portion. In some embodiments, the stop portion 518 is configured as a stop sleeve member that extends circumferentially about a distal longitudinal portion of the drive sleeve 516, and thereby is configured to freely rotate about the stop sleeve 518 (about the axis X-X). The stop portion 518 also extends radially over a distal longitudinal free end 568 of the drive sleeve 516, and radially over a proximal longitudinal necking or radial edge 566 of the drive sleeve 516, as shown in FIGS. 14-16, to longitudinally fix the stop portion 518 with respect to the drive sleeve 516. The stop portion 518 may thereby extend circumferentially about a distal longitudinal portion of the drive sleeve 516 that extends between the necking or radial edge 566 and the distal longitudinal free end 568 of the drive sleeve 516. The

In another aspect, the driver 510 differs from the depth setting bit driver 10, the depth setting bit driver 110, the depth setting bit driver 210, the depth setting bit driver 310 and the depth setting bit driver 410 in the configuration of the drive/clutch portion of the drive cavity 521 of the drive sleeve 518, and thereby the driving and non-driving configurations of the drive sleeve 516 with the drive member 512 and the drive adapter 514 in the longitudinally extended engaged arrangement and the longitudinally retracted disengaged arrangement. As shown in FIGS. 14-16, the driver 510 is configured such that the drive/clutch portion of the drive cavity 521 of the drive sleeve 518 only includes the first drive/clutch portion 546 with the first set of bearing surfaces 551 as the third bearing surfaces (and not the second drive/clutch portion 48 with the second set of bearing surfaces 552 as the third bearing surfaces). Accordingly, the driver 510 is configured such that in the longitudinally retracted disengaged arrangement, the first bearing surfaces 525 of the bearing portion 526 of the drive member 512 are in engagement with the third bearing surfaces 551 of the first drive/clutch portion 546 to rotationally lock the drive member 512 and the drive sleeve 516, and the second bearing surfaces 535 of the bearing portion 534 of the drive connector 514 are positioned within the disengagement portion 547 of the drive cavity 521 of the drive sleeve 516 to rotationally unlock the drive connector 514 and the drive sleeve 516. In the longitudinally retracted disengaged arrangement, the driver 510 is thereby configured to rotate both the drive member 512 and the drive sleeve 516.

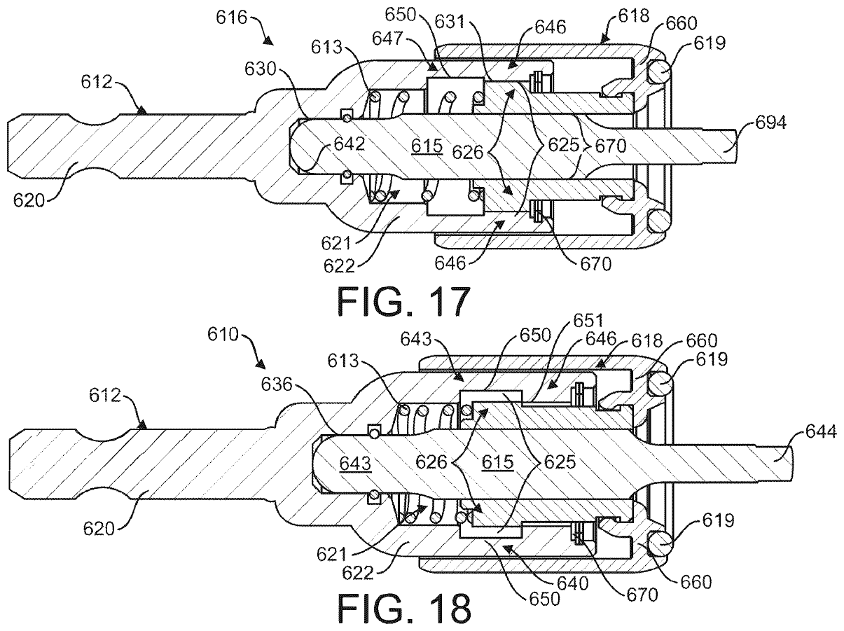

Another exemplary depth setting bit driver 510 according to present disclosure is shown in FIGS. 17 and 18. The depth setting bit driver 510 is similar to the depth setting bit driver 10, the depth setting bit driver 110, the depth setting bit driver 210, the depth setting bit driver 310, the depth setting bit driver 410 and the depth setting bit driver 510 and therefore like reference numerals preceded with “6” are used to indicate like components, aspects, functions or features, and the description above directed to thereto equally applies, and is not repeated for brevity and clarity purposes.

As shown in FIGS. 17 and 18, the driver 610 comprises a drive member 612 comprising a drive spindle 620 and a drive body 622. The drive body 622 includes a drive cavity 621 that includes a bit retention cavity portion 636 and a clutch portion 646. As shown in FIGS. 17 and 18, the driver 610 also comprises drive cavity 616 extending within the clutch portion 646 of the drive cavity 21 comprising a longitudinal through hole 670 defining a non-circular cross-section that is substantially aligned with the bit retention portion 636, and a bearing portion 626 comprising plurality of external circumferentially-arranged first bearing surfaces 625 that are extended along two-dimensions.

The driver 610 also comprises a stop portion or sleeve 418 comprising a sleeve portion extending about a portion of the drive body 622 and an end stop portion 660 rotationally coupled and longitudinally fixed to the drive cavity 616, as shown in FIGS. 17 and 18. The stop portion 660 comprises a longitudinal aperture substantially aligned with the bit retention portion 636 of the drive cavity 621 and the through hole 670 of the drive cavity 616. The driver 610 also includes a resilient member 613 that biases the drive cavity 616 and the stop portion 618 into a longitudinally extended engaged arrangement with respect to the drive member 612, as shown in FIGS. 17 and 18.

As shown in FIGS. 17 and 18, the drive cavity 621 comprises a disengagement portion 647 with non-bearing internal surfaces 650 and an engagement portion 646 with a plurality of internal circumferentially-arranged second bearing surfaces 651, the disengagement portion 647 being positioned longitudinally between the engagement portion 646 and the drive spindle 620.

The driver 612 (such as the drive member 612, the drive cavity 616 and the stop portion 618) is configured such that in longitudinally extended engaged arrangement, as shown in FIG. 17, the first bearing surfaces 625 extend within the engagement portion 646 of the drive cavity 621 and abut second bearing surfaces 651 to rotationally lock the drive member 612 and the drive cavity 616. The driver 612 (such as the drive member 612, the drive cavity 616 and the stop portion 618) is also configured to rearrange from the longitudinally extended engaged arrangement to a longitudinally retracted disengaged arrangement, as shown in FIG. 18, with the first bearing surfaces 625 positioned within the disengagement portion 647 of the drive cavity 621 to rotationally unlock the drive member 612 and the drive cavity 616.

As shown in FIGS. 17 and 18, the drive body 622 may extend longitudinally from the drive spindle 620, and the drive cavity 621 may extend longitudinally into the drive body 622 from a longitudinal end of the drive body 622 toward the drive spindle 620. The resilient member 613 may also extend longitudinally within the drive cavity 621, such as between a longitudinal end of the drive cavity 621 and a longitudinal end of the drive cavity 616, as shown in FIGS. 17 and 18. In some embodiments, the resilient member 613 is a spring.

In some embodiments, the non-bearing internal surfaces 650 of the disengagement portion 647 may define a larger radial/lateral opening within the drive cavity 621 than an opening within the drive cavity 621 defined by the second bearing surfaces 651 of the engagement portion 646 such that the first bearing surfaces 625 are radially spaced therefrom in the longitudinally retracted disengaged arrangement, as shown in FIG. 18.

In some embodiments, the bearing portion 626 that defines the first bearing surfaces 625 is retained within the drive cavity 621. In some embodiments, an outer portion of the drive cavity 621 comprises a groove and a retaining ring or member 70 retained within the groove, and the retaining member 70 defines an inner opening that is smaller than the bearing portion 626 to prevent the bearing portion 626 from translating out from the drive cavity 621, as shown in FIGS. 17 and 18.

As shown in FIG. 18, in the longitudinally retracted disengaged arrangement, the first bearing surfaces 625 are positioned within and radially spaced from the non-bearing surfaces 650 of the disengagement portion 647 of the drive cavity 621. In some embodiments, the drive cavity 616 comprises a drive portion that defines that the first bearing surfaces 625, and an intermediate portion that is longitudinally adjacent to the drive portion, as shown in FIGS. 17 and 18. In such embodiments, in the longitudinally retracted disengaged arrangement, the intermediate portion extends within the engagement portion 646 of the drive cavity 621 and is radially spaced from the second bearing surfaces 651, as shown in FIG. 17.

In some embodiments, the drive cavity 621, the longitudinal through hole 670 and the longitudinal aperture of the stop portion 660 are configured such that the bit 15 extends longitudinally therethrough from bit retention portion 636, as shown in FIGS. 17 and 18. In some embodiments, the longitudinal through hole 670 is configured to engage a driving portion of the bit that defines a non-circular cross-section such that the drive cavity 616 and the bit are rotationally fixed.

As shown in FIGS. 17 and 18, in some embodiments, the bit retention portion 636 of the drive cavity 621 comprises a groove and a resilient retaining ring or member within retained within the groove, and a base end portion 642 of the bit 6154 comprises a groove configured to house the resilient retaining member therein when the base end portion 642 is translated into the resilient retaining member so that the depth setting bit driver 10 is removably coupled with the bit 615.

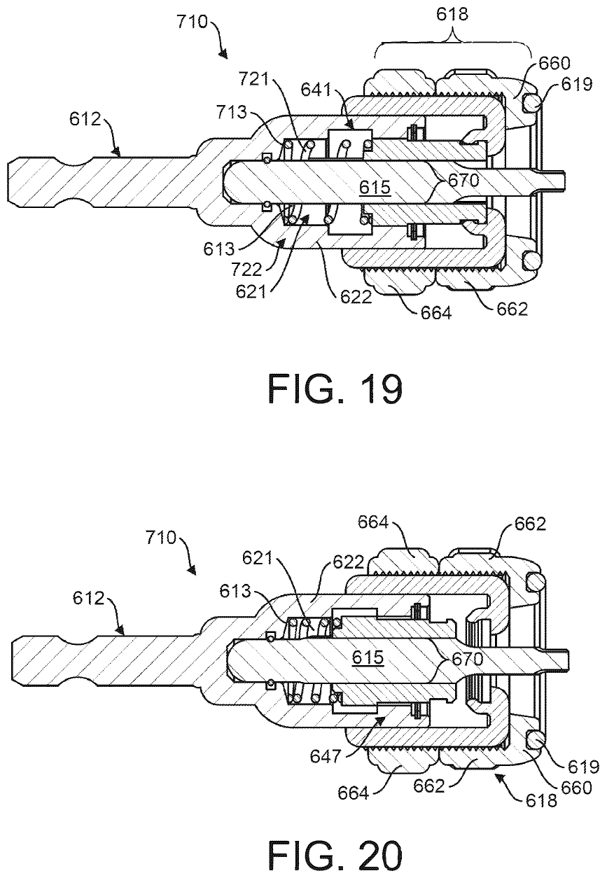

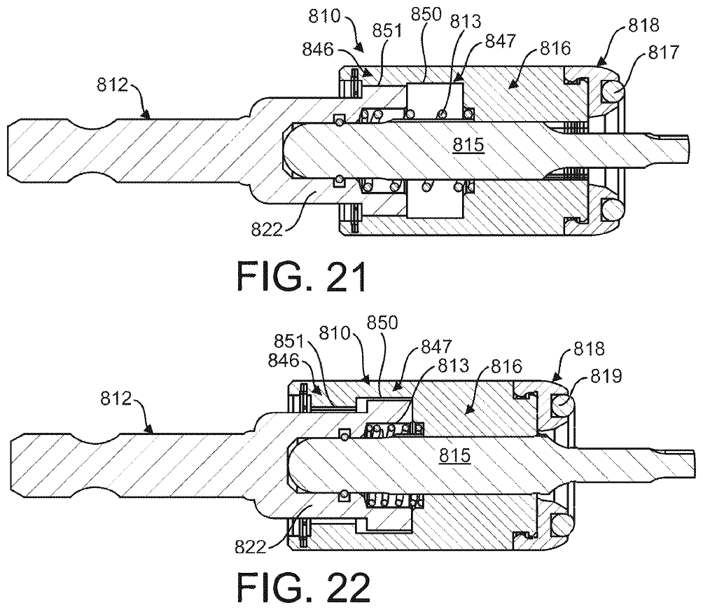

Another exemplary depth setting bit driver 710 according to present disclosure is shown in FIGS. 19 and 20. The depth setting bit driver 710 is substantially similar to the depth setting bit driver 610, and therefore like reference numerals preceded with “7” are used to indicate like components, aspects, functions or features, and the description above directed to thereto equally applies, and is not repeated for brevity and clarity purposes.

As shown in FIGS. 19 and 20, the depth setting bit driver 710 differs from the depth setting bit driver 610 in the configuration of the stop portion 718. While the stop portion 618 of the depth setting bit driver 610 is configured as a fixed longitudinal length stop portion, the stop portion 718 of the depth setting bit driver 710 is configured as an adjustable longitudinal length stop portion. As shown in FIGS. 19 and 20, the stop portion 718 comprises a depth adjustment portion 762 threadably coupled with the sleeve portion 716. The stop portion 718, via the depth adjustment portion 762, is threadably longitudinally movable along the stop portion 718 to adjust the longitudinal location/length of the stop portion 718, and thereby the longitudinal length of the driver 710.

As also shown in FIGS. 19 and 20, in some embodiments, the stop portion 618 may further comprise a locking member 742 threadably coupled with the sleeve portion 716 longitudinally adjacent to the depth adjustment member 762. The locking member 742 is threadably longitudinally movable along the stop portion 718 and into abutment with the depth adjustment member 762 to longitudinally and rotationally lock/fix the position of the depth adjustment member 762.

Another exemplary depth setting bit driver 810 according to present disclosure is shown in FIGS. 21 and 22. The depth setting bit driver 810 is similar to the depth setting bit driver 10, the depth setting bit driver 110, the depth setting bit driver 210, the depth setting bit driver 310, the depth setting bit driver 410, the depth setting bit driver 510, the depth setting bit driver 610 and the depth setting bit driver 710, and therefore like reference numerals preceded with “8” are used to indicate like components, aspects, functions or features, and the description above directed to thereto equally applies, and is not repeated for brevity and clarity purposes.

As shown in FIGS. 21 and 22, depth setting bit driver 810 differs from depth setting bit drivers 10-710 in the configuration of the bearing portions 846, 826 and bearing surfaces 851 and 825 thereof, respectively, and the disengagement portion 847. Accordingly, the arrangement and configuration of the bearing portions 846, 826 and bearing surfaces 851 and 825 thereof, respectively, and the disengagement portion 847, and the respective components, in the longitudinally elongated engaged arrangement and the longitudinally retracted disengaged arrangement differs, as shown in FIGS. 21 and 22.

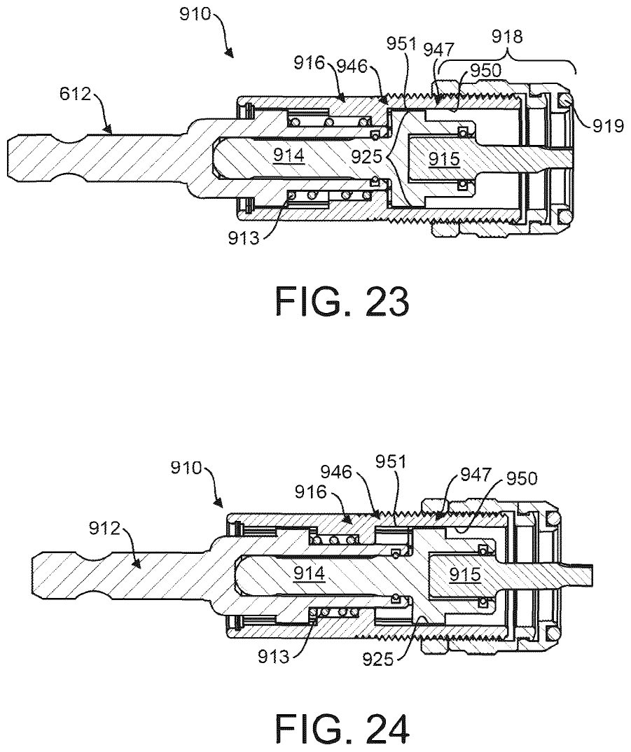

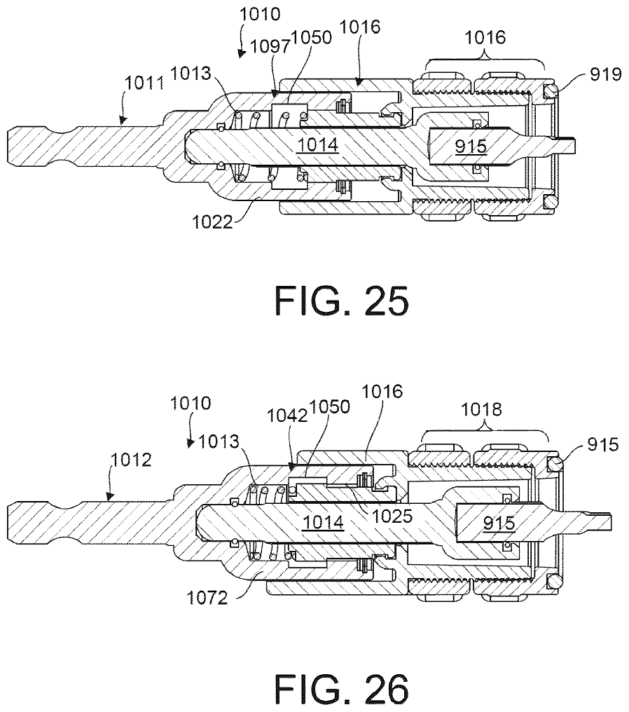

Another exemplary depth setting bit driver 910 according to present disclosure is shown in FIGS. 23 and 24. The depth setting bit driver 910 is similar to the depth setting bit driver 10, the depth setting bit driver 110, the depth setting bit driver 210, the depth setting bit driver 310, the depth setting bit driver 410, the depth setting bit driver 510, the depth setting bit driver 610, the depth setting bit driver 710 and the depth setting bit driver 810, and therefore like reference numerals preceded with “9” are used to indicate like components, aspects, functions or features, and the description above directed to thereto equally applies, and is not repeated for brevity and clarity purposes.

As shown in FIGS. 23 and 24, depth setting bit driver 910 differs from depth setting bit drivers 10-810 in the configuration of the bearing portions 946, 926 and bearing surfaces 951 and 925 thereof, respectively, and the disengagement portion 947. Accordingly, the arrangement and configuration of the bearing portions 946, 926 and bearing surfaces 951 and 925 thereof, respectively, and the disengagement portion 947, and the respective components, in the longitudinally elongated engaged arrangement and the longitudinally retracted disengaged arrangement differs, as shown in FIGS. 23 and 24.

Another exemplary depth setting bit driver 1010 according to present disclosure is shown in FIGS. 25 and 26. The depth setting bit driver 10 is similar to the depth setting bit driver 10, the depth setting bit driver 110, the depth setting bit driver 210, the depth setting bit driver 310, the depth setting bit driver 410, the depth setting bit driver 510, the depth setting bit driver 610, the depth setting bit driver 710, the depth setting bit driver 810 and the depth setting bit driver 910, and therefore like reference numerals preceded with “10” are used to indicate like components, aspects, functions or features, and the description above directed to thereto equally applies, and is not repeated for brevity and clarity purposes.

As shown in FIGS. 25 and 26, depth setting bit driver 1010 differs from depth setting bit drivers 10-910 in the configuration of the bearing portions 1046, 1026 and bearing surfaces 1051 and 1025 thereof, respectively, and the disengagement portion 1047. Accordingly, the arrangement and configuration of the bearing portions 1046, 1026 and bearing surfaces 1051 and 1025 thereof, respectively, and the disengagement portion 1047, and the respective components, in the longitudinally elongated engaged arrangement and the longitudinally retracted disengaged arrangement differs, as shown in FIGS. 25 and 26.

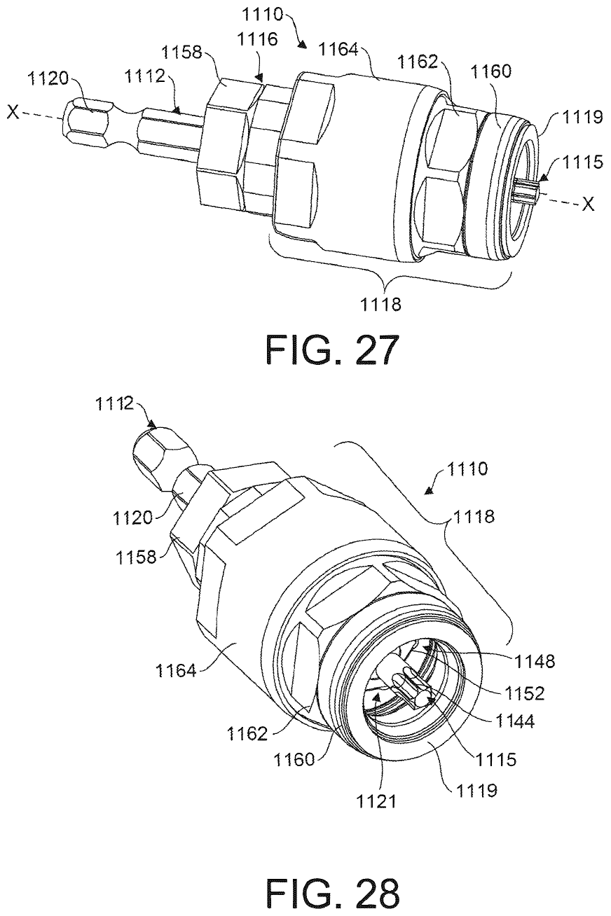

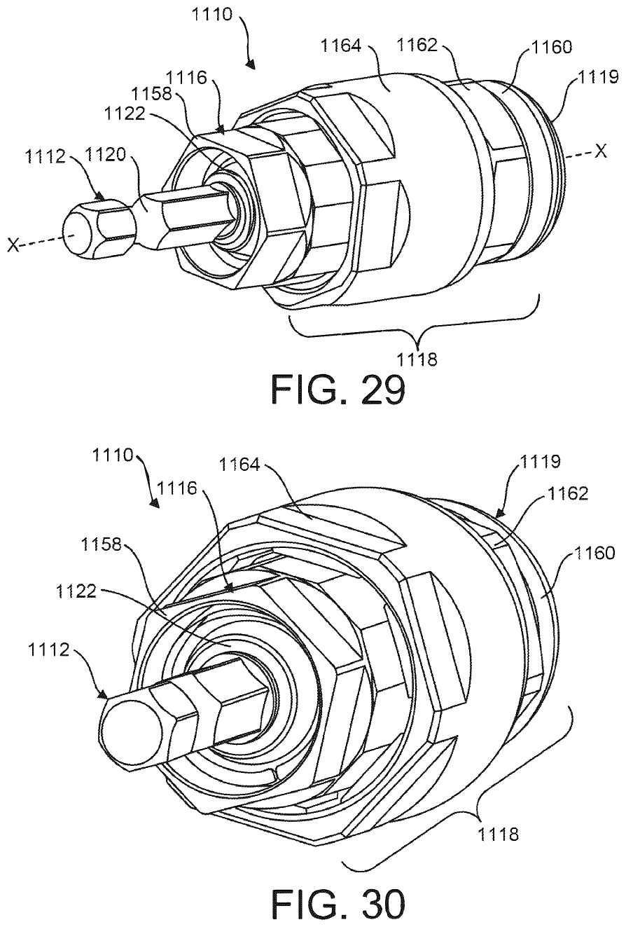

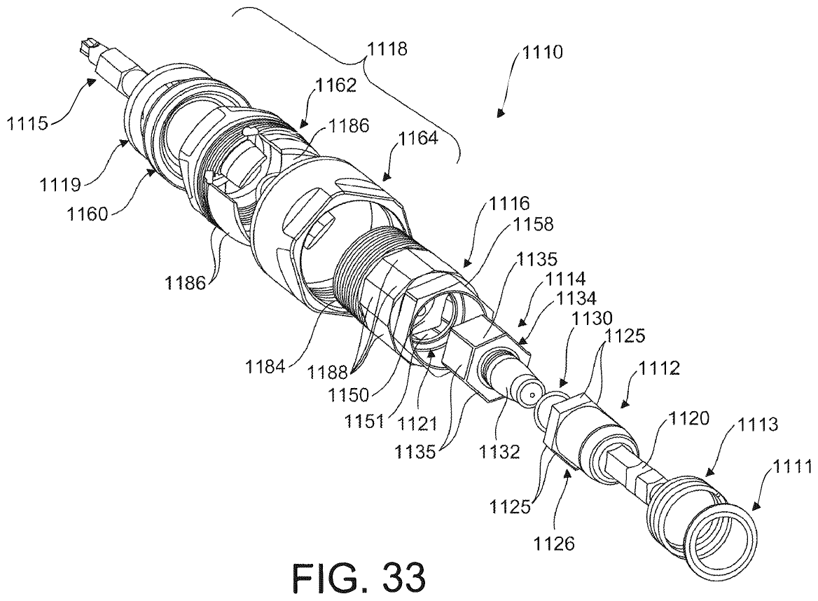

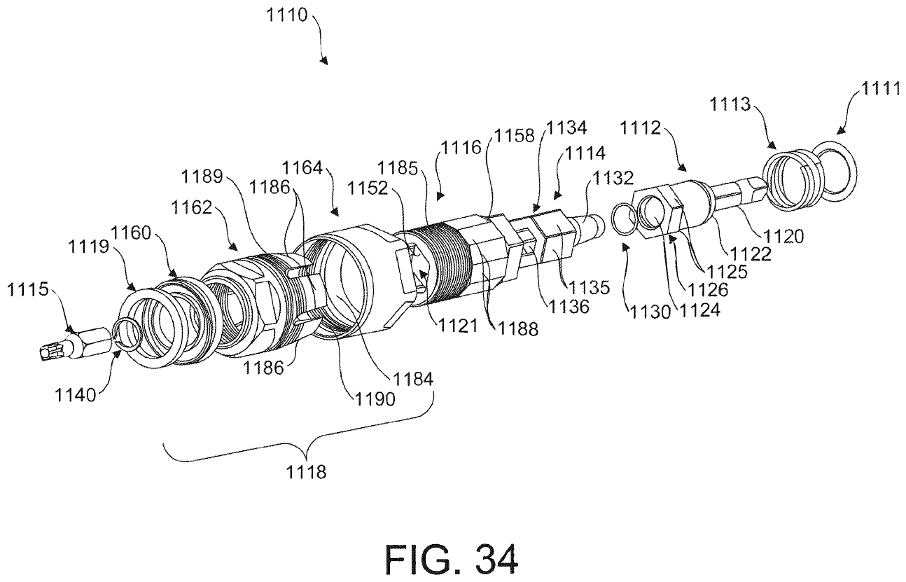

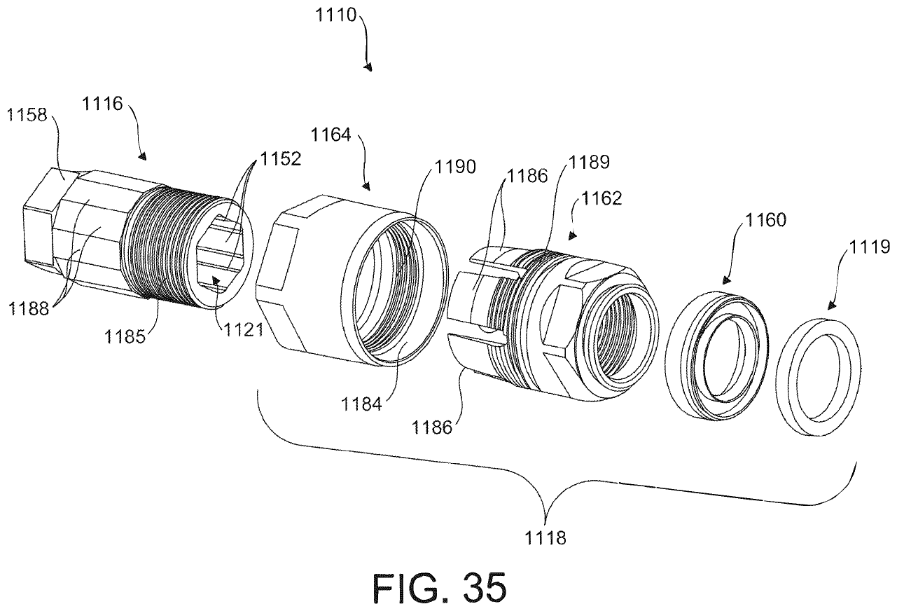

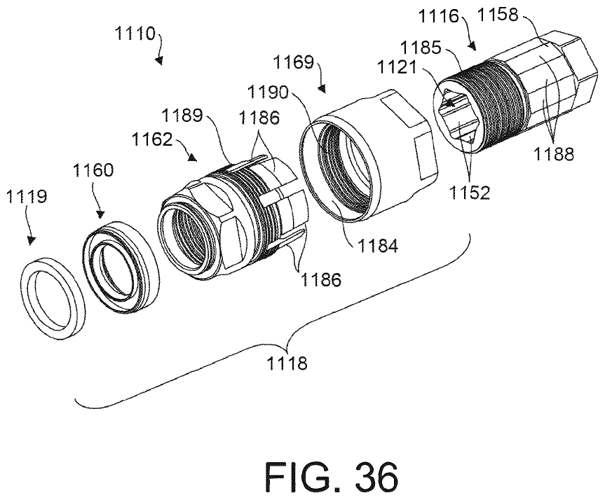

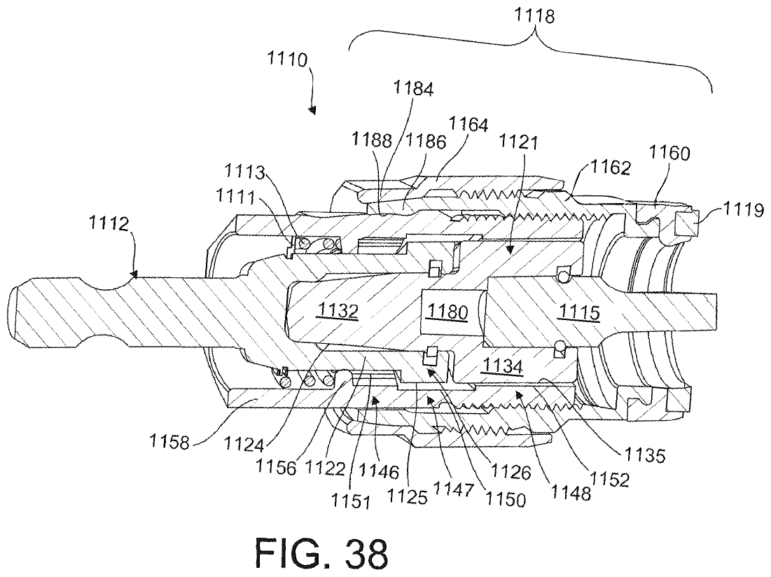

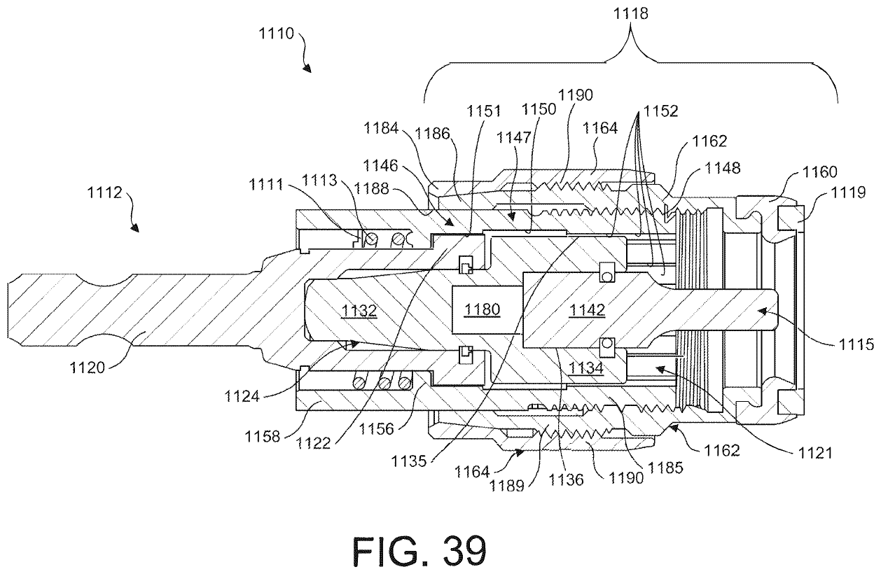

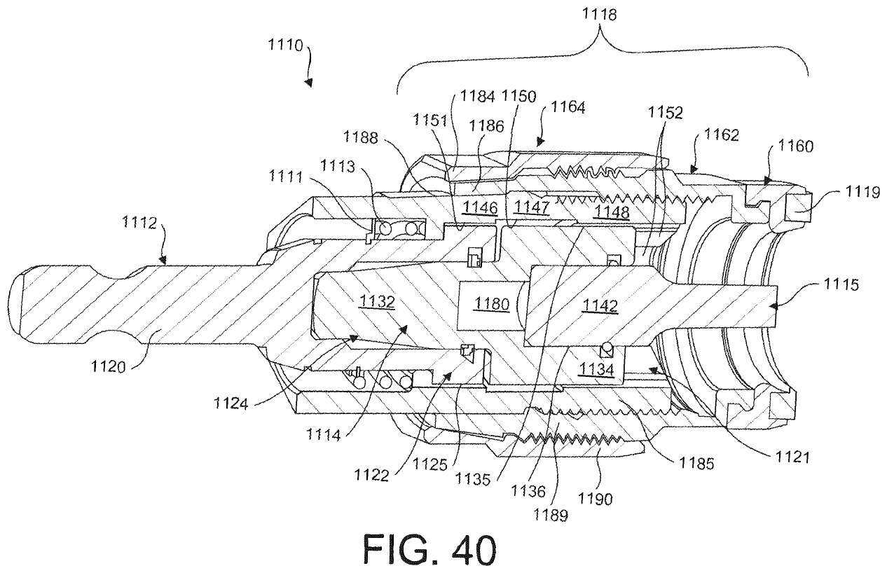

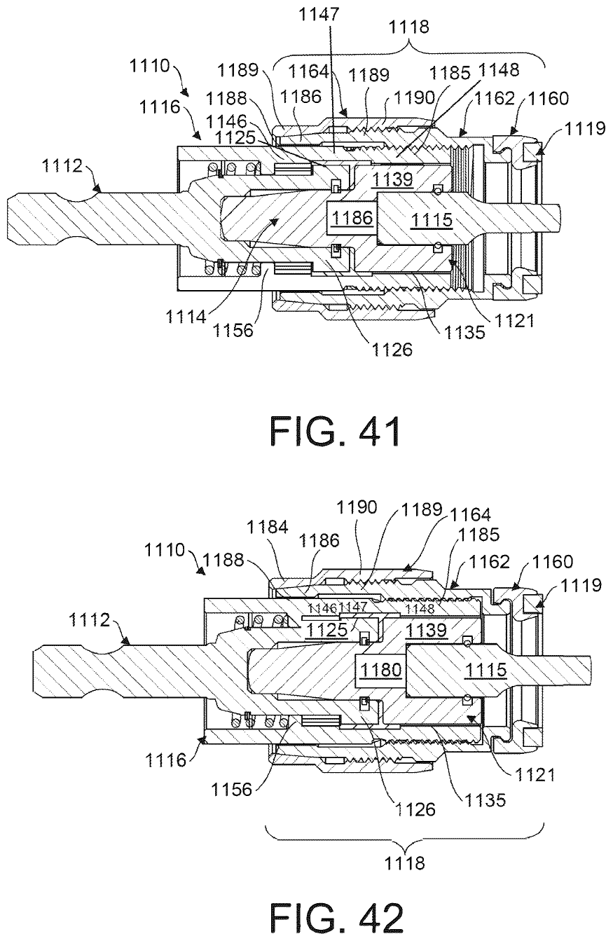

Another exemplary depth setting bit driver 1110 according to present disclosure is shown in FIGS. 27-44 The depth setting bit driver 1110 is similar to the depth setting bit driver 10, the depth setting bit driver 110, the depth setting bit driver 210, the depth setting bit driver 310, the depth setting bit driver 410, the depth setting bit driver 510, the depth setting bit driver 610, the depth setting bit driver 710, the depth setting bit driver 810, the depth setting bit driver 910 and the depth setting bit driver 1010, and therefore like reference numerals preceded with “11” are used to indicate like components, aspects, functions or features, and the description above directed to thereto equally applies, and is not repeated for brevity and clarity purposes.

As shown in FIGS. 27-44, the depth setting bit driver 1110 differs from depth setting bit drivers 10-1010 in the configuration of its bit/fastener driving depth adjustment feature of the drive sleeve portion 1116 and a stop portion 1118. It is noted that the configuration and operation of the depth setting bit driver 1110 with respect to the engage driving state and the disengage non-driving state, and thereby the setting/driving of a bit 1115 (and fastener driven thereby, for example), is substantially similar to the depth setting bit driver 10 of FIGS. 1-6, and thus like reference numerals are used to indicate like components, aspects, functions or features, and the description above directed thereto equally applies, and is not repeated here for brevity and clarity purposes.

As shown in FIGS. 27-44, the drive sleeve portion 1116 and the stop portion 1118 of the driver 1110 are configured to securely lock the longitudinal length adjustment/arrangement thereof to securely fix/set the driving depth configuration/setting of the driver 1110 (i.e., the depth that the tip 1144 of a bit 1115, and thereby the head of a fastener driven, is driven to when the driver 1110 disengages/transitions to the disengaged non-driving state). The locking feature of the drive sleeve portion 1116 and the stop portion 1118 of the driver 1110 is particularly advantageous for use with impact and hammer rotatory tools as it sufficiently withstands the high repetitive loads thereof without loosening and/or unlocking.

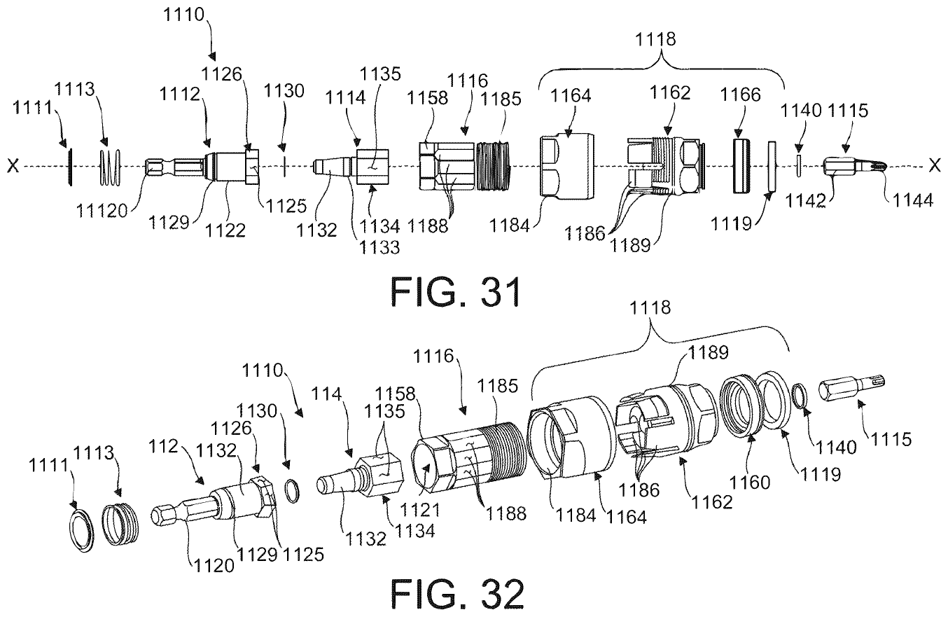

As shown in FIGS. 31-44, the drive sleeve 1116 includes an externally threaded portion 1185 and an external locking bearing portion 1188. The external threaded portion 1185 and the external bearing portion 1188 may be longitudinally arranged, and the external threaded portion 1185 may be arranged at a distal end portion of the drive sleeve 1116. The external bearing portion 1188 may comprise a plurality of circumferentially arranged bearing surfaces that are longitudinally extended. In the illustrated exemplary embodiment shown in FIGS. 31-44, the external bearing portion 1188 comprises ten circumferentially arranged bearing surfaces. However, the external bearing portion 1188 may comprise more than, or less than, ten circumferentially arranged bearing surfaces. In some embodiments, the circumferentially arranged bearing surfaces of the external bearing portion 1188 may be substantially flat or planar surfaces that extending parallel to the axis X-X in the longitudinal direction.

With continued reference to FIGS. 31-44, the stop portion 1118 comprises the depth adjustment member 1162 threadably longitudinally-telescopingly movably/adjustably coupled/arranged over/on the drive sleeve 1116, and the locking member 1164 threadably longitudinally-telescopingly movably/adjustably coupled/arranged over/on the stop portion 1118. The depth adjustment member 1162 may thereby comprise internal threads (an internally threaded portion), such as at a distal portion thereof, that is threadably engaged with the external threaded portion 1185 of the drive sleeve 1116. The depth adjustment member 1162 can thereby rotated/torqued with respect to the drive sleeve 1116 to adjust the longitudinal relative arrangement thereof and, thereby, adjust the longitudinal length of the stop portion 1118 (e.g., the resilient workpiece engagement member/material 1119) relative to the bit 1119, and thereby the depth setting/configuration of the driver 1110, as discussed above.

To securely lock the longitudinal arrangement of the depth adjustment member 1162 and the drive sleeve 1116, and thus the depth setting/configuration of the driver 1110, the depth adjustment member 1162 comprises a collet portion with a plurality of radially deflectable/resiliently deformable fingers, members or bands 1186 (formed by one or more longitudinal opening or slots), as shown in FIGS. 31-44. The locking member 1164 may comprise internal threads (an internally threaded portion), such as at a distal portion thereof, that is threadably engaged with an external threaded portion 1189 of the depth adjustment member 1162. The locking member 1164 can thereby rotated/torqued with respect to the depth adjustment member 1162 to adjust the longitudinal relative arrangement thereof.

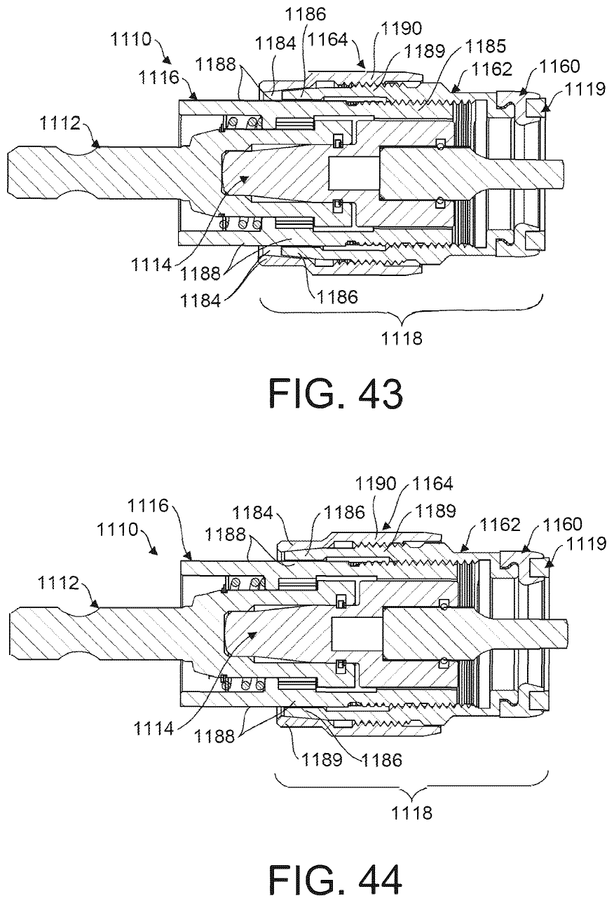

As shown in FIGS. 31-44, the locking member 1164 may comprise an internal bearing locking surface 1184 (which may be annular). As shown in FIG. 43, the internal bearing locking surface 1184 and/or the exterior surface/side of the deflectable fingers 1186 may be configured such that the internal bearing locking surface 1184 deflects the deflectable fingers 1186 radially inwardly and into contact with (and forced against) the external bearing portion 1188 (e.g., the flat surfaces thereof) in a first relative longitudinal position of the depth adjustment member 1162 and the locking member 1164 to lock depth setting/configuration of the driver 1110, as discussed above. The internal bearing locking surface 1184 and/or the exterior surface of the deflectable fingers 1186 may comprise a sloped surface that is angled with respect to the axis X-X as it/they extend longitudinally to effectuate such radial deflection of the deflectable fingers 1186. Similarly, as shown in FIG. 44, the internal bearing locking surface 1184 and/or the exterior surface/side of the deflectable fingers 1186 may be configured such that the internal bearing locking surface 1184 allows the deflectable fingers 1186 to defect radially outwardly and not in contact with (or not forced against) the external bearing portion 1188 (e.g., the flat surfaces thereof) in a second relative longitudinal position of the depth adjustment member 1162 and the locking member 1164 to unlock depth setting/configuration of the driver 1110 and allow the depth setting/configuration of the driver 1110 to be adjusted via longitudinal translation of the depth adjustment member 1162, as discussed above.

As shown in FIGS. 27-44, the depth setting bit driver 1110 also differs from depth setting bit drivers 10-1010 in the configuration of the cavity in the longitudinal end portion 1160 and the resilient workpiece engagement member/material 1119. As shown, the workpiece engagement member/material 1119 may be of a non-circular cross-section, such as a square or other rectilinear shape, and the cavity in the longitudinal end portion 1160 that accommodates/houses the workpiece engagement member/material 1119 likewise configured. The non-circular/square/rectilinear configuration of the cavity in the longitudinal end portion 1160 and the resilient workpiece engagement member/material 1119 advantageously prevents dislodging of the resilient workpiece engagement member/material 1119 from the longitudinal end portion 1160 when the driver 1110 is driven by a rotary hammer or impact gun/driver.

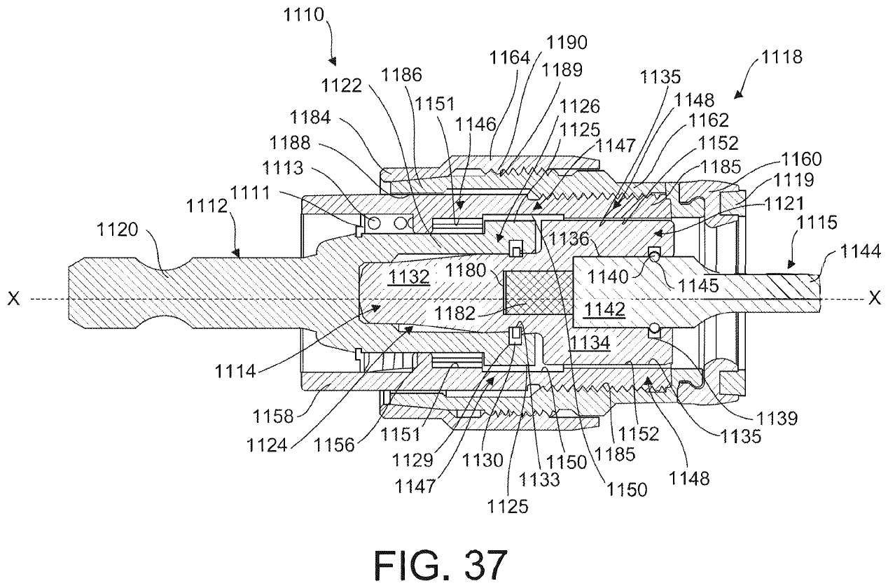

As shown in FIGS. 27-44, the depth setting bit driver 1110 also differs from depth setting bit drivers 10-1010 in the configuration of the inner adapter cavity 24 of the drive body 22 of the drive member 1112. As shown, the inner adapter cavity 24 of the drive body 22 of the drive member 1112 may include a retention cavity 1180, and a magnet or magnetic member 1182 positioned therein, that is configured to magnetically retain a bit 1115 within the inner adapter cavity 24, as shown in FIG. 37.

It is to be understood that the above description is intended to be illustrative, and not restrictive. For example, the above-described examples (and/or aspects thereof) may be used in combination with each other. For example, one feature, component, sub-assembly, configuration, component shape, arrangement or the like, of one or more aspects of one driver embodiment may be equally employed or employed in a functional fashion to a different driver embodiment. Accordingly, the features of each of the disclosed driver embodiments are hereby disclosed with respect to each other disclosed driver embodiments, and the features thereof may be combined, swapped, duplicated, etc. It is hereby contemplated that the adjustable and non-adjustable stop sleeve embodiments disclosed herein, and the features thereof, may be equally or substantially similarly employed in each of the disclosed driver embodiments. Similarly, it is hereby contemplated that the bearing surface configurations of the driver sleeve embodiments disclosed herein, and the features thereof, may be equally or substantially similarly employed in each of the disclosed driver embodiments. Similarly, it is hereby contemplated that the configurations and arrangements of the bearing surfaces of the driver embodiments disclosed herein, and the features thereof, may be equally or substantially similarly employed in each of the disclosed driver embodiments.

In addition, many modifications may be made to adapt a particular situation or material to the teachings of the various examples without departing from their scope. While dimensions and types of materials may be described herein, they are intended to define parameters of some of the various examples, and they are by no means limiting to all examples and are merely exemplary. Many other examples will be apparent to those of skill in the art upon reviewing the above description. The scope of the various examples should, therefore, be determined with reference to the appended claims, along with the full scope of equivalents to which such claims are entitled.

In the appended claims, the terms “including” and “in which” are used as the plain-English equivalents of the respective terms “comprising” and “wherein. ” Moreover, in the following claims, the terms “first,” “second,” and “third,” etc. are used merely as referee labels, and are not intended to impose numerical, structural or other requirements on their objects. Forms of term “based on” herein encompass relationships where an element is partially based on as well as relationships where an element is entirely based on. Forms of the term “defined” encompass relationships where an element is partially defined as well as relationships where an element is entirely defined. Further, the limitations of the following claims are not written in means-plus-function format and are not intended to be interpreted based on 35 U.S. C. § 112, sixth paragraph, unless and until such claim limitations expressly use the phrase “means for” followed by a statement of function cavity of further structure. It is to be understood that not necessarily all such objects or advantages described above may be achieved in accordance with any particular example. Thus, for example, those skilled in the art will recognize that the devices, systems and methods described herein may be embodied or carried out in a manner that achieves or optimizes one advantage or group of advantages as taught herein without necessarily achieving other objects or advantages as may be taught or suggested herein.

While the disclosure has been described in detail in connection with only a limited number of examples, it should be readily understood that the disclosure is not limited to such disclosed examples. Rather, this disclosure can be modified to incorporate any number of variations, alterations, substitutions or equivalent arrangements not heretofore described, but which are commensurate with the spirit and scope of the disclosure. Additionally, while various examples have been described, it is to be understood that aspects of the disclosure may include only one example or some of the described examples. Also, while some embodiments are described as having a certain number of elements, it will be understood that the examples can be practiced with less than or greater than the certain number of elements.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

What is claimed is:

1. A depth setting bit driver configured to rotate a bit about a longitudinal axis of the driver, comprising:
a drive member comprising a drive spindle and a drive body comprising an inner adapter cavity and a plurality of external circumferentially-arranged first bearing surfaces that are extended along two-dimensions;
a drive connector comprising a coupling portion rotationally coupled and longitudinally fixed within the adapter cavity and a first bearing portion comprising an inner bit retention cavity and a plurality of external circumferentially-arranged second bearing surfaces that are extended along two directions;
a drive sleeve comprising a longitudinal drive cavity comprising a disengagement portion with non-bearing internal surfaces and a clutch portion comprising a plurality of internal circumferentially-arranged third bearing surfaces that are extended along two directions; and
a stop portion rotationally coupled to the drive sleeve comprising a longitudinal free end portion configured to engage a workpiece,
wherein the drive sleeve is telescopingly coupled with the drive member and the drive connector between a longitudinally extended engaged arrangement and a longitudinally retracted disengaged arrangement with respect thereto,
wherein, in the longitudinally extended engaged arrangement, the first and second bearing surfaces are in engagement with the third bearing surfaces to rotationally lock the drive member and the drive connector, and
wherein, in the longitudinally retracted disengaged arrangement, one of the first and second bearing surfaces are positioned within the disengagement portion of the drive cavity to rotationally unlock the drive member and the drive connector.

2. The depth setting bit driver of claim 1, wherein the drive body extends longitudinally from the drive spindle, and the adapter cavity extends longitudinally into the drive body from a longitudinal end of the drive body toward the spindle.

3. The depth setting bit driver of claim 1, wherein the adapter cavity and the coupling portion each comprise an annular coupling recesses, and wherein the coupling portion and the adapter cavity are rotationally coupled and longitudinally fixed via a retaining member extending within the coupling recesses.

4. The depth setting bit driver of claim 1, wherein the inner bit retention cavity defines a non-circular cross-section and is configured to retain and engage a driving stem of the bit that defines a non-circular cross-section such that the drive connector and the bit are rotationally fixed when the driving stem is positioned within the bit retention cavity.

5. The depth setting bit driver of claim 1, wherein the non-bearing internal surfaces of the disengagement portion define a larger opening within the drive cavity than an opening within the drive cavity defined by the third bearing surfaces of the clutch portion.

6. The depth setting bit driver of claim 1, wherein an end portion of the first bearing portion defines the second bearing surfaces and is retained within the drive cavity.

7. The depth setting bit driver of claim 6, wherein the drive cavity of the drive sleeve further comprises a neck portion and a bias portion, the neck portion being positioned longitudinally between the bias portion and the disengagement portion, and wherein the neck portion defines an opening within the drive cavity that is smaller than the end portion of the first bearing portion, and further comprising a resilient member extending within the bias portion of the drive cavity longitudinally between the neck portion and a retaining member coupled to the drive body in a resiliently deformed state, the resilient member exerting a biasing force against the neck portion that biases the drive sleeve into the longitudinally extended engaged arrangement.

8. The depth setting bit driver of claim 1, wherein the drive sleeve is biased into the longitudinally extended engaged arrangement.

9. The depth setting bit driver of claim 1, wherein the first and bearing surfaces face radially outwardly, and the third bearing surfaces face radially inwardly.

10. The depth setting bit driver of claim 1, wherein the first, second and third bearing surfaces extend longitudinally and are oriented parallel to the longitudinal axis as they extend longitudinally.

11. The depth setting bit driver of claim 1, wherein the first and second bearing surfaces are side surfaces of first spline features of the drive member and the drive connector, respectively, and the third bearing surfaces are side surfaces of second spline features of the drive sleeve, the first and second spline features forming a spline connection.

12. The depth setting bit driver of claim 1, wherein the first, second and third bearing surfaces comprise flat surfaces.

13. The depth setting bit driver of claim 1, wherein the first, second and third bearing surfaces are extended longitudinally, and are extended along a lateral direction that extends perpendicular to the longitudinal axis, and wherein the lateral direction extends radially from the longitudinal axis or perpendicular to a radial direction that extends radially from the longitudinal axis.

14. The depth setting bit driver of claim 1, wherein, in the longitudinally retracted disengaged arrangement, the one of the first and second bearing surfaces are positioned within the disengagement portion of the drive cavity and radially spaced from the non-bearing internal surfaces the disengagement portion.

15. The depth setting bit driver of claim 1, wherein the diver is configured such that a tip of the bit extends past the longitudinal free end portion a first distance when a stem portion of the bit is retained within the bit retention cavity and the driver is in the longitudinally extended engaged arrangement, and such that the tip of the bit extends past the longitudinal free end portion a second distance that is greater than the first distance when the stem portion of the bit is retained within the bit retention cavity and the driver is in the longitudinally retracted disengaged arrangement.

16. The depth setting bit driver of claim 1, wherein the longitudinal free end portion comprises a resilient material, the resilient material defining a longitudinal free end of the driver configured to engage the workpiece.

17. The depth setting bit driver of claim 16, wherein the stop portion comprises a stop sleeve member that is rotationally coupled and longitudinally fixed to the drive sleeve, wherein the resilient material is coupled to a longitudinal end portion of the stop sleeve member, and wherein the stop sleeve member does not extend radially peripherally over the resilient material.

18. The depth setting bit driver of claim 1, wherein the stop portion is rotationally coupled and longitudinally fixed to the drive sleeve.

19. The depth setting bit driver of claim 18, wherein:
the stop portion comprises a stop sleeve member that extends circumferentially about a distal longitudinal portion of the drive sleeve and radially over a distal longitudinal free end of the drive sleeve; or
wherein the stop portion comprises a stop sleeve member that extends circumferentially about a distal longitudinal portion of the drive sleeve and radially over a distal longitudinal free end of the drive sleeve.

20. The depth setting bit driver of claim 1, wherein the stop portion is rotationally coupled and longitudinally adjustably coupled to the drive sleeve.

21. The depth setting bit driver of claim 20, wherein the stop portion comprises a depth adjustment member threadably coupled with the drive sleeve such that the first depth adjustment member is threadably longitudinally movable along the drive sleeve to adjust the longitudinal position of the longitudinal free end of the stop portion, and wherein the stop portion further comprises a locking member threadably coupled with the drive sleeve longitudinally adjacent to the depth adjustment member such that the locking member is threadably longitudinally movable along the drive sleeve.

22. The depth setting bit driver of claim 21, wherein the stop portion further comprises a locking member threadably coupled with the drive sleeve longitudinally adjacent to the depth adjustment member such that the locking member is threadably longitudinally movable along the drive sleeve, wherein the stop portion further comprises a collet portion with radially deflectable finger portions, and wherein the locking member comprises an internal bearing surface that deflects the deflectable finger portions into compressive abutment with the drive sleeve in a first relative longitudinal arrangement with the stop portion to lock the longitudinal arrangement of the depth adjustment member and the drive sleeve, and a allows the deflectable finger portions to deflect out of compressive abutment with the drive sleeve in a second relative longitudinal arrangement with the stop portion, wherein the stop portion further comprises a stop member rotationally coupled and longitudinally fixed to the depth adjustment member, the stop member comprising the longitudinal free end portion, and wherein the stop member comprises a resilient stop portion that comprises a non-circular cross-section.

23. The depth setting bit driver of claim 1, wherein, in the longitudinally retracted disengaged arrangement, the first bearing surfaces are in engagement with the third bearing surfaces to rotationally lock the drive member and the drive sleeve, and the second bearing surfaces are positioned within the disengagement portion of the drive cavity of the drive sleeve to rotationally unlock the drive connector and the drive sleeve.

24. The depth setting bit driver of claim 1, wherein, in the longitudinally retracted disengaged arrangement, the second bearing surfaces are in engagement with the third bearing surfaces to rotationally lock the drive connector and the drive sleeve, and the first bearing surfaces are positioned within the disengagement portion of the drive cavity of the drive sleeve to rotationally unlock the drive member and the drive sleeve.

25. The depth setting bit driver of claim 24, wherein the clutch portion of the drive cavity comprises a first clutch portion with a first set of bearing surfaces of the third bearing surfaces, and a second clutch portion with a second set of bearing surfaces of the third bearing surfaces, and wherein the disengagement portion is positioned longitudinally between the first and second clutch portions, wherein, in the longitudinally retracted disengaged arrangement, the second bearing surfaces are in engagement with the second set of bearing surfaces of the third bearing surfaces, and, wherein, in the longitudinally elongated engaged arrangement, the first bearing surfaces are in engagement with the first set of bearing surfaces of the third bearing surfaces and the second bearing surfaces are in engagement with the second set of bearing surfaces of the third bearing surfaces.

26. A kit, comprising:
the depth setting bit driver according to claim 1; and
at least one bit, the at least one bit configured to removably couple within the adapter cavity and be rotated by the depth setting bit driver in the longitudinally extended engaged arrangement.

27. The kit of claim 26, wherein the at least one bit comprises a first bit configured as a fastener driving bit comprising a driving tip with a non-circular cross-section, wherein the kit further comprises a plurality of fasteners comprising a head portion and an externally-threaded shaft portion extending longitudinally from the head portion, and wherein the head portions of the fasteners comprise a driving feature with a non-circular cross-section configured to mate with the driving tip of the fastener driving bit.
